(19) United States
(12) Patent Application Publication
(10) Pub. No.: US 2025/0371127 A1
(43) Pub. Date: Dec. 4, 2025

(54) SYSTEMS AND METHODS FOR MANAGING USE OF GENERATIVE ARTIFICIAL INTELLIGENCE (AI)

(71) Applicant: Martin Tremblay, Montreal (CA)

(72) Inventor: Martin Tremblay, Montreal (CA)

(21) Appl. No.: 19/218,450

(22) Filed: May 26, 2025

Related U.S. Application Data
(60) Provisional application No. 63/655,011, filed on Jun. 2, 2024.
(60) Provisional application No. 63/703,926, filed on Oct. 5, 2024.

(51) Int. Cl. G06F 21/44; G06F 3/0484

(52) U.S. Cl. CPC G06F 21/44; G06F 3/0484

(57) ABSTRACT

Systems and methods for enhancing, controlling and/or otherwise managing use of generative artificial intelligence (AI), such as in business, education, interpersonal communication, etc., including to assess use of generative AI (e.g., whether and/or how generative AI is used) and/or to use generative AI more effectively. For example, in various embodiments, these systems and methods may: characterize generative AI usage in producing work products; bill based on generative AI usage; ensure human validation of AI-generated content; enable user control over data for generative AI training, review of AI-generated content, and/or other generative AI considerations; facilitate management of rights to AI-generated work products; detect generative AI usage in interpersonal communication, education and/or other situations; adapt AI-generated content of online communications based on their context; personalize AI-generated messages and other content; trigger use of generative AI based on speech; limit or otherwise avoid generative AI usage; and/or improve use of generative AI in other ways.

### CROSS-REFERENCE TO RELATED APPLICATIONS

This application claims the benefit under 35 USC 119(e) of U.S. Provisional Patent Application 63/655,011 filed on Jun. 2, 2024, and U.S. Provisional Patent Application 63/703,926 filed on Oct. 5, 2024, which are incorporated by reference herein.

### FIELD

This disclosure relates generally to artificial intelligence (AI) and, more particularly, to use of generative AI to generate text, images, audio, program code, and/or other content.

### BACKGROUND

Generative artificial intelligence (AI) has significantly advanced and provides capabilities to create text, images, audio, program code, and/or other content that can mimic human creativity.

As generative AI technologies are increasingly used in various contexts, issues can arise. For example: in business, it may be relevant yet difficult to know whether and/or how generative AI is used for work products; in education, there may be AI-assisted cheating; in interpersonal communication, AI-generated messages may be inappropriate, misleading or undesirable in some situations; etc.

For these and/or other reasons, there is a need for improvements in use of generative AI, such as to ensure transparency, control and accountability to maintain trust, authenticity, and ethicality.

### SUMMARY

In accordance with various aspects, there are provided systems and methods for enhancing, controlling and/or otherwise managing use of generative artificial intelligence (AI), such as in business, education, interpersonal communication, etc., including to assess use of generative AI (e.g., whether and/or how generative AI is used) and/or to use generative AI more effectively.

For instance, in various embodiments, these systems and methods may: characterize generative AI usage in producing work products (e.g., AI-generated content vs. human-generated content, private data vs. public data, etc.); bill based on generative AI usage (e.g., charges for AI-generated content vs. for human-generated content, charges based on private data vs. based on public data, etc.); ensure human validation of AI-generated content (e.g., by tracking and/or compelling human review); enable user control over data for generative AI training, review of AI-generated content, and/or other generative AI considerations (e.g., client control of whether and/or how client private data can be used, user control of whether AI-generated messages are reviewed before transmission, etc.); facilitate management of rights to AI-generated work products (e.g., ownership, licensing, etc.); detect generative AI usage in interpersonal communication, education and/or other situations (e.g., by scanning and/or otherwise looking for markers, particular inputs, and/or similarities in multiple work products, monitoring user activity, etc.; for notifying recipients, teachers, proctors, employers, etc.; etc.); adapt AI-generated content of online communications based on their context (e.g., by adjusting their language, tone, content, etc. based on their recipients, times, types, purposes, etc.); personalize AI-generated messages and other content (e.g., by training on user personal data); trigger use of generative AI based on speech (e.g., at certain moments during discussions or other events, in voice messages, etc.); limit or otherwise avoid generative AI usage (e.g., based on an extent of that usage for work, school, communication, and/or other purposes, based on certain contexts, etc.); and/or improve use of generative AI in other ways.

As examples, in some embodiments, there is provided a system for managing use of generative AI, the system comprising memory and a processor configured to:
track and record an extent of AI usage in creating a work product; and output information about the extent of AI usage in creating the work product;
track and record an extent of AI usage in creating a work product; and output information indicative of an amount of AI-generated content of the work product and an amount of human-generated content of the work product;
distinguish between private data and public data used by AI in creating a work product; and output information indicative of an amount of AI-generated content of the work product based on the private data and an amount of AI-generated content of the work product based on the public data;
differentiate charges for AI-generated content of a work product and charges for human-generated content of the work product; and output information indicative of costs for the AI-generated content of the work product and costs for the human-generated content of the work product;
differentiate charges for generative AI based on private data to generate a work product and charges for generative AI based on public data to generate the work product; and output information indicative of costs for the generative AI based on the private data to generate the work product and costs for the generative AI based on the public data to generate the work product;
at least one of track and compel human review of AI-generated content of a work product; and output information indicative of the human review of the AI-generated content of the work product;
allow a client to specify preferences regarding use of private data of the client by generative AI; and produce AI-generated content in accordance with the preferences;
determine a manner of managing rights to a work product generated by the generative AI; and convey a statement on the rights to the work product in association with the work product;
insert a marker in a question of an exam or assignment; and scan a work product submitted in response to the question to determine whether the marker is present in the work product and, if so, output information flagging use of generative AI in producing the work product;
compare work products from multiple individuals in a group to identify similarities indicative of generative AI usage; and output information flagging use of generative AI in producing the work products;
determine that a particular input from a user submitted to a generative AI system is indicative of potential unpermitted use of generative AI; and perform an action related to the potential unpermitted use of generative AI;
monitor activity of a user who uses a communication device during a test and determine that generative AI is used during the test; and perform an action related to use of generative AI during the test;
detect AI-generated content in an online communication directed to a user; and notify the user of AI usage in the online communication;
analyze a context of a communication involving a user; and produce an AI-generated message on behalf of the user based on the context of the communication involving the user;
train a generative model of a generative AI system based on personal data of a user; and generate content for the user with the generative AI system trained on the personal data of the user;
allow a user to specify criteria determining whether AI-generated content produced by a generative AI system is to be reviewed by the user before transmission; and transmit the AI-generated content upon or without review by the user based on the criteria;
provide a control in a graphical user interface (GUI) of a communication device of a user for the user to specify whether the user allows or denies data from the user to be used by the generative AI; if the user allows the data from the user to be used by the generative AI, utilize the generative Al for generating AI-generated content based on the data from the user and output the AI-generated content; and, if the user denies the data from the user to be used by the generative AI, deny use of the data from the user by the generative AI;
provide a control in a GUI of a communication device of a user for the user to select which parts of data from the user are allowed to be used by the generative AI; utilize the generative AI for generating AI-generated content based on at least one of the parts of the data from the user; and output the AI-generated content;
provide a control in a GUI of a communication device of a user for the user to specify that the user allows first data from the user to be used by the generative AI and denies second data from the user to be used by the generative AI; utilize the generative AI to generate AI-generated content based on the first data from the user; output the AI-generated content; and deny use of the second data from the user by the generative AI;
receive a request for AI-generated content; provide a control in a GUI of a communication device of a user for the user to specify whether the user allows or denies data from the user to be used by the generative AI; generate the AI-generated content; if the user allows the data from the user to be used by the generative AI, utilize the generative AI to generate at least part of the AI-generated content based on the data from the user; if the user denies the data from the user to be used by the generative AI, process the request without use of the data from the user by the generative AI; and output the AI-generated content;
determine a time sensitivity of a message directed to a user; utilize the generative AI to generate AI-generated content based on the time sensitivity of the message directed to the user; and output the AI-generated content via a GUI of a communication device;
determine that the generative AI is used to generate AI-generated content related to a communication involving a user; and output a notification notifying the user that the generative AI is used to generate the AI-generated content related to the communication involving the user;
utilize the generative AI to generate an AI-generated message for a user based on emails of the user and instant messages of the user; and output the AI-generated message for the user via a communication device;
process a message directed to a user to determine contextual aspects of the message that include at least two of a topic of the message, a purpose of the message, a situation mentioned in the message, and an individual mentioned in the message; utilize the generative AI to generate an AI-generated response to the message based on the contextual aspects of the message; and output the AI-generated response via a communication device;
obtain speech related to a user; and utilize the generative AI to generate AI-generated content based on the speech related to the user;
detect AI-generated content in a message directed to a user; generate a response to the message directed to the user such that the response to the message directed to the user includes AI-generated content responding to the AI-generated content of the message directed to the user; and transmit the response to the message directed to the user to an originator of the message directed to the user;
track and record an extent of usage of the generative AI; and limit use of the generative AI based on the extent of usage of the generative AI;
analyze a context of a communication involving a user; and avoid generation of an AI-generated message on behalf of the user by the generative AI based on the context of the communication involving the user;
utilize the generative AI to generate AI-generated content based on a message from a sender to a recipient; output the AI-generated content on a communication device; and convey an indication that the AI-generated content has been generated by the generative AI on the communication device;
monitor activity of at least one human working on a document; assess usage of the generative AI in creating the document; generate information characterizing content of the document based on the activity of the at least one human working on the document and the usage of the generative AI in creating the document; and output the information characterizing the content of the document;
allow a user to opt for AI-generated content generable by the generative AI on behalf of the user to be transmitted without being reviewed by the user; receive messages directed to the user; utilize the generative AI to generate AI-generated responses to the messages on behalf of the user; and transmit the AI-generated responses without the user reviewing the AI-generated responses if the user opts for the AI-generated content generable by the generative AI on behalf of the user to be transmitted without being reviewed by the user;
determine that an AI-generated message to a recipient on behalf of a user is to be generated; obtain information regarding the recipient; utilize the generative AI to generate the AI-generated message such that the AI-generated message includes a statement based on the information regarding the recipient; and transmit the AI-generated message to the recipient;
receive a message directed to a user and sent by a sender; utilize the generative AI to generate an AI-generated response to the message on behalf of the user such that the AI-generated response includes a statement related to the sender but unrelated to content of the message; and transmit the AI-generated response to the sender;
provide a control in a GUI of a communication device of a user for the user to specify whether the user allows or denies data from the user to be used for training the generative AI; if the user allows the data from the user to be used for training the generative AI, utilize the data from the user for training of the generative AI; and, if the user denies the data from the user to be used for training the generative AI, deny use of the data from the user for training the generative AI;
obtain speech during a meeting in which a user participates; receive input regarding the meeting from the user via a communication device of the user; utilize the generative AI to generate AI-generated content regarding the meeting based on the speech and the input regarding the meeting from user; and output the AI-generated content regarding the meeting via the communication device of the user; and/or
utilize the generative AI to generate AI-generated content for a user based on emails of the user, instant messages of the user, and work products of the user; and output the AI-generated content for the user via a communication device.

As other examples, in some embodiments, there is provided a method for managing use of generative AI, the method comprising:
tracking and recording an extent of AI usage in creating a work product; and outputting information about the extent of AI usage in creating the work product;
tracking and recording an extent of AI usage in creating a work product; and outputting information indicative of an amount of AI-generated content of the work product and an amount of human-generated content of the work product;
distinguishing between private data and public data used by AI in creating a work product; and outputting information indicative of an amount of AI-generated content of the work product based on the private data and an amount of AI-generated content of the work product based on the public data;
differentiating charges for AI-generated content of a work product and charges for human-generated content of the work product; and outputting information indicative of costs for the AI-generated content of the work product and costs for the human-generated content of the work product;
differentiating charges for generative AI based on private data to generate a work product and charges for generative AI based on public data to generate the work product; and outputting information indicative of costs for the generative AI based on the private data to generate the work product and costs for the generative AI based on the public data to generate the work product;
at least one of tracking and compelling human review of AI-generated content of a work product; and outputting information indicative of the human review of the AI-generated content of the work product;
allowing a client to specify preferences regarding use of private data of the client by generative AI; and producing AI-generated content in accordance with the preferences;
determining a manner of managing rights to a work product generated by the generative AI; and conveying a statement on the rights to the work product in association with the work product;
inserting a marker in a question of an exam or assignment; and scanning a work product submitted in response to the question to determine whether the marker is present in the work product and, if so, outputting information flagging use of generative AI in producing the work product;
comparing work products from multiple individuals in a group to identify similarities indicative of generative AI usage; and outputting information flagging use of generative AI in producing the work products;
determining that a particular input from a user submitted to a generative AI system is indicative of potential unpermitted use of generative AI; and performing an action related to the potential unpermitted use of generative AI;
monitoring activity of a user who uses a communication device during a test and determining that generative AI is used during the test; and performing an action related to use of generative AI during the test;
detecting AI-generated content in an online communication directed to a user; and notifying the user of AI usage in the online communication;
analyzing a context of a communication involving a user; and producing an AI-generated message on behalf of the user based on the context of the communication involving the user;
training a generative model of a generative AI system based on personal data of a user; and generating content for the user with the generative AI system trained on the personal data of the user;
allowing a user to specify criteria determining whether AI-generated content produced by a generative AI system is to be reviewed by the user before transmission; and transmitting the AI-generated content upon or without review by the user based on the criteria;
providing a control in a GUI of a communication device of a user for the user to specify whether the user allows or denies data from the user to be used by the generative AI; if the user allows the data from the user to be used by the generative AI, utilizing the generative AI to generate AI-generated content based on the data from the user and outputting the AI-generated content; and, if the user denies the data from the user to be used by the generative AI, denying use of the data from the user by the generative AI;
providing a control in a GUI of a communication device of a user for the user to select which parts of data from the user are allowed to be used by the generative AI; utilizing the generative AI to generate AI-generated content based on at least one of the parts of the data from the user; and outputting the AI-generated content;
providing a control in a GUI of a communication device of a user for the user to specify that the user allows first data from the user to be used by the generative AI and denies second data from the user to be used by the generative AI; utilizing the generative AI to generate AI-generated content based on the first data from the user; outputting the AI-generated content; and denying use of the second data from the user by the generative AI;
receiving a request for AI-generated content; provide a control in a GUI of a communication device of a user for the user to specify whether the user allows or denies data from the user to be used by the generative AI; generating the AI-generated content; if the user allows the data from the user to be used by the generative AI, utilizing the generative AI to generate at least part of the AI-generated content based on the data from the user; if the user denies the data from the user to be used by the generative AI, processing the request without use of the data from the user by the generative AI; and outputting the AI-generated content;
determining a time sensitivity of a message directed to a user; utilizing the generative AI to generate AI-generated content based on the time sensitivity of the message directed to the user; and outputting the AI-generated content via a GUI of a communication device;
determining that the generative AI is used to generate AI-generated content related to a communication involving a user; and outputting a notification notifying the user that the generative AI is used to generate the AI-generated content related to the communication involving the user;
utilizing the generative AI to generate an AI-generated message for a user based on emails of the user and instant messages of the user; and outputting the AI-generated message for the user via a communication device;
processing a message directed to a user to determine contextual aspects of the message that include at least two of a topic of the message, a purpose of the message, a situation mentioned in the message, and an individual mentioned in the message; utilizing the generative AI to generate an AI-generated response to the message based on the contextual aspects of the message; and outputting the AI-generated response via a communication device;
obtaining speech related to a user; and utilizing the generative AI to generate AI-generated content based on the speech related to the user;
detecting AI-generated content in a message directed to a user; generating a response to the message directed to the user such that the response to the message directed to the user includes AI-generated content responding to the AI-generated content of the message directed to the user; and transmitting the response to the message directed to the user to an originator of the message directed to the user;
tracking and recording an extent of usage of the generative AI; and limiting use of the generative AI based on the extent of usage of the generative AI;
analyzing a context of a communication involving a user; and avoiding generation of an AI-generated message on behalf of the user by the generative AI based on the context of the communication involving the user;
utilizing the generative AI to generate AI-generated content based on a message from a sender to a recipient; outputting the AI-generated content on a communication device; and conveying an indication that the AI-generated content has been generated by the generative AI on the communication device;
monitoring activity of at least one human working on a document; assessing usage of the generative AI in creating the document; generating information characterizing content of the document based on the activity of the at least one human working on the document and the usage of the generative AI in creating the document; and outputting the information characterizing the content of the document;
allowing a user to opt for AI-generated content generable by the generative AI on behalf of the user to be transmitted without being reviewed by the user; receive messages directed to the user; utilizing the generative AI to generate AI-generated responses to the messages on behalf of the user; and transmitting the AI-generated responses without the user reviewing the AI-generated responses if the user opts for the AI-generated content generable by the generative AI on behalf of the user to be transmitted without being reviewed by the user;
determining that an AI-generated message to a recipient on behalf of a user is to be generated; obtain information regarding the recipient; utilizing the generative AI to generate the AI-generated message such that the AI-generated message includes a statement based on the information regarding the recipient; and transmitting the AI-generated message to the recipient;
receiving a message directed to a user and sent by a sender; utilizing the generative AI to generate an AI-generated response to the message on behalf of the user such that the AI-generated response includes a statement related to the sender but unrelated to content of the message; and transmitting the AI-generated response to the sender;
providing a control in a GUI of a communication device of a user for the user to specify whether the user allows or denies data from the user to be used for training the generative AI; if the user allows the data from the user to be used for training the generative AI, utilizing the data from the user for training of the generative AI; and, if the user denies the data from the user to be used for training the generative AI, denying use of the data from the user for training the generative AI;
obtaining speech during a meeting in which a user participates; receiving input regarding the meeting from the user via a communication device of the user; utilizing the generative AI to generate AI-generated content regarding the meeting based on the speech and the input regarding the meeting from user; and outputting the AI-generated content regarding the meeting via the communication device of the user; and/or
utilizing the generative AI to generate AI-generated content for a user based on emails of the user, instant messages of the user, and work products of the user; and outputting the AI-generated content for the user via a communication device.

As other examples, in some embodiments, there is provided a non-transitory computer-readable storage medium storing a program executable by a computing apparatus to manage use of generative AI, wherein the program when executed causes the computing apparatus to:
track and record an extent of AI usage in creating a work product; and output information about the extent of AI usage in creating the work product;
track and record an extent of AI usage in creating a work product; and output information indicative of an amount of AI-generated content of the work product and an amount of human-generated content of the work product;
distinguish between private data and public data used by AI in creating a work product; and output information indicative of an amount of AI-generated content of the work product based on the private data and an amount of AI-generated content of the work product based on the public data;
differentiate charges for AI-generated content of a work product and charges for human-generated content of the work product; and output information indicative of costs for the AI-generated content of the work product and costs for the human-generated content of the work product;
differentiate charges for generative AI based on private data to generate a work product and charges for generative AI based on public data to generate the work product; and output information indicative of costs for the generative AI based on the private data to generate the work product and costs for the generative AI based on the public data to generate the work product;
at least one of track and compel human review of AI-generated content of a work product; and output information indicative of the human review of the AI-generated content of the work product;
allow a client to specify preferences regarding use of private data of the client by generative AI; and produce AI-generated content in accordance with the preferences;
determine a manner of managing rights to a work product generated by the generative AI; and convey a statement on the rights to the work product in association with the work product;
insert a marker in a question of an exam or assignment; and scan a work product submitted in response to the question to determine whether the marker is present in the work product and, if so, output information flagging use of generative AI in producing the work product;
compare work products from multiple individuals in a group to identify similarities indicative of generative AI usage; and output information flagging use of generative AI in producing the work products;
determine that a particular input from a user submitted to a generative AI system is indicative of potential unpermitted use of generative AI; and perform an action related to the potential unpermitted use of generative AI;
monitor activity of a user who uses a communication device during a test and determine that generative AI is used during the test; and perform an action related to use of generative AI during the test;
detect AI-generated content in an online communication directed to a user; and notify the user of AI usage in the online communication;
analyze a context of a communication involving a user; and produce an AI-generated message on behalf of the user based on the context of the communication involving the user;
train a generative model of a generative AI system based on personal data of a user; and generate content for the user with the generative AI system trained on the personal data of the user;
allow a user to specify criteria determining whether AI-generated content produced by a generative AI system is to be reviewed by the user before transmission; and transmit the AI-generated content upon or without review by the user based on the criteria;
provide a control in a GUI of a communication device of a user for the user to specify whether the user allows or denies data from the user to be used by the generative AI; if the user allows the data from the user to be used by the generative AI, utilize the generative AI for generating AI-generated content based on the data from the user and output the AI-generated content; and, if the user denies the data from the user to be used by the generative AI, deny use of the data from the user by the generative AI;
provide a control in a GUI of a communication device of a user for the user to select which parts of data from the user are allowed to be used by the generative AI; utilize the generative AI for generating AI-generated content based on at least one of the parts of the data from the user; and output the AI-generated content;
provide a control in a GUI of a communication device of a user for the user to specify that the user allows first data from the user to be used by the generative AI and denies second data from the user to be used by the generative AI; utilize the generative AI to generate AI-generated content based on the first data from the user; output the AI-generated content; and deny use of the second data from the user by the generative AI;
receive a request for AI-generated content; provide a control in a GUI of a communication device of a user for the user to specify whether the user allows or denies data from the user to be used by the generative AI; generate the AI-generated content; if the user allows the data from the user to be used by the generative AI, utilize the generative AI to generate at least part of the AI-generated content based on the data from the user; if the user denies the data from the user to be used by the generative AI, process the request without use of the data from the user by the generative AI; and output the AI-generated content
determine a time sensitivity of a message directed to a user; utilize the generative AI to generate AI-generated content based on the time sensitivity of the message directed to the user; and output the AI-generated content via a GUI of a communication device;
determine that the generative AI is used to generate AI-generated content related to a communication involving a user; and output a notification notifying the user that the generative AI is used to generate the AI-generated content related to the communication involving the user;
utilize the generative AI to generate an AI-generated message for a user based on emails of the user and instant messages of the user; and output the AI-generated message for the user via a communication device;
process a message directed to a user to determine contextual aspects of the message that include at least two of a topic of the message, a purpose of the message, a situation mentioned in the message, and an individual mentioned in the message; utilize the generative AI to generate an AI-generated response to the message based on the contextual aspects of the message; and output the AI-generated response via a communication device;
obtain speech related to a user; and utilize the generative AI to generate AI-generated content based on the speech related to the user;
detect AI-generated content in a message directed to a user; generate a response to the message directed to the user such that the response to the message directed to the user includes AI-generated content responding to the AI-generated content of the message directed to the user; and transmit the response to the message directed to the user to an originator of the message directed to the user;
track and record an extent of usage of the generative AI; and limit use of the generative AI based on the extent of usage of the generative AI;
analyze a context of a communication involving a user; and avoid generation of an AI-generated message on behalf of the user by the generative AI based on the context of the communication involving the user;
utilize the generative AI to generate AI-generated content based on a message from a sender to a recipient; output the AI-generated content on a communication device; and convey an indication that the AI-generated content has been generated by the generative AI on the communication device;
monitor activity of at least one human working on a document; assess usage of the generative AI in creating the document; generate information characterizing content of the document based on the activity of the at least one human working on the document and the usage of the generative AI in creating the document; and output the information characterizing the content of the document;
allow a user to opt for AI-generated content generable by the generative AI on behalf of the user to be transmitted without being reviewed by the user; receive messages directed to the user; utilize the generative AI to generate AI-generated responses to the messages on behalf of the user; and transmit the AI-generated responses without the user reviewing the AI-generated responses if the user opts for the AI-generated content generable by the generative AI on behalf of the user to be transmitted without being reviewed by the user;
determine that an AI-generated message to a recipient on behalf of a user is to be generated; obtain information regarding the recipient; utilize the generative AI to generate the AI-generated message such that the AI-generated message includes a statement based on the information regarding the recipient; and transmit the AI-generated message to the recipient;
receive a message directed to a user and sent by a sender; utilize the generative AI to generate an AI-generated response to the message on behalf of the user such that the AI-generated response includes a statement related to the sender but unrelated to content of the message; and transmit the AI-generated response to the sender;
provide a control in a GUI of a communication device of a user for the user to specify whether the user allows or denies data from the user to be used for training the generative AI; if the user allows the data from the user to be used for training the generative AI, utilize the data from the user for training of the generative AI; and, if the user denies the data from the user to be used for training the generative AI, deny use of the data from the user for training the generative AI;
obtain speech during a meeting in which a user participates; receive input regarding the meeting from the user via a communication device of the user; utilize the generative AI to generate AI-generated content regarding the meeting based on the speech and the input regarding the meeting from user; and output the AI-generated content regarding the meeting via the communication device of the user; and/or
utilize the generative AI to generate AI-generated content for a user based on emails of the user, instant messages of the user, and work products of the user; and output the AI-generated content for the user via a communication device.

These and other aspects will now become apparent to those of ordinary skill upon review of a description of embodiments that follows in conjunction with accompanying drawings.

### BRIEF DESCRIPTION OF DRAWINGS

A detailed description of embodiments is provided below, by way of example only, with reference to accompanying drawings, in which:

FIG. 1 shows an embodiment of a system for enhancing, controlling and/or otherwise managing use of generative artificial intelligence (AI), which may be referred to as an AI-use management system;

FIG. 2 shows an embodiment of a generative AI system;

FIG. 3 shows components of the AI-use management system;

FIGS. 4 to 24 show examples of operation of the AI-use management system in various embodiments; and

FIG. 25 shows an embodiment of a computing apparatus.

It is to be expressly understood that the description and drawings are only for purposes of describing and illustrating certain embodiments and are an aid for understanding. They are not intended to be and should not be limiting.

### DETAILED DESCRIPTION OF EMBODIMENTS

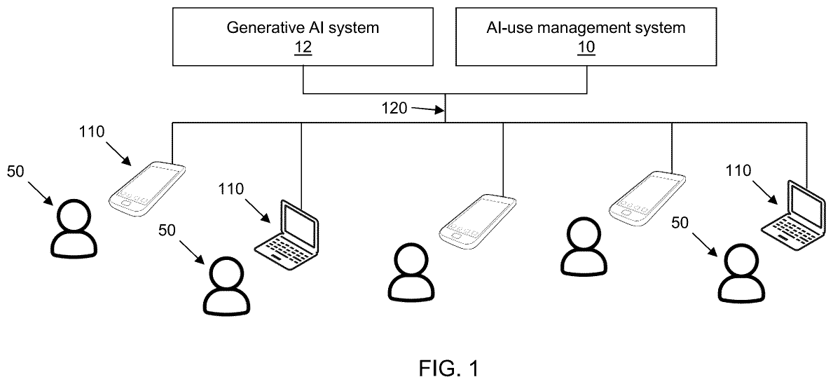

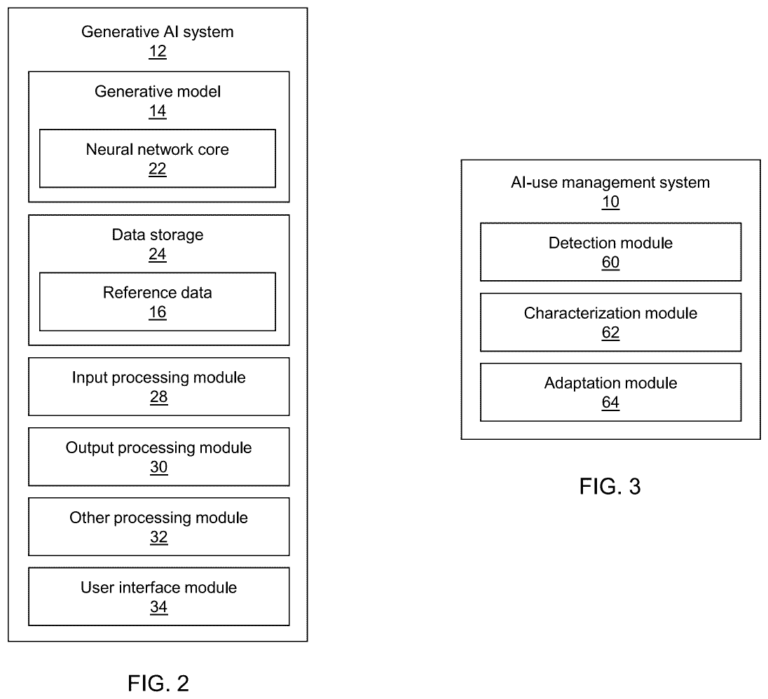

FIGS. 1 to 3 show an embodiment of a system 10 for enhancing, controlling and/or otherwise managing use of generative artificial intelligence (AI), such as in business, education, interpersonal communication, etc., including to assess use of generative AI (e.g., whether and/or how generative AI is used) and/or to use generative AI more effectively.

For example, in various embodiments, this AI-use management system 10 may be configured to:
characterize generative AI usage in producing work products (e.g., AI-generated content vs. human-generated content, private data vs. public data, etc.);
bill based on generative AI usage (e.g., charges for AI-generated content vs. for human-generated content, charges based on private data vs. based on public data, etc.);
ensure human validation of AI-generated content (e.g., by tracking and/or compelling human review);
enable user control over data for generative AI training, review of AI-generated content, and/or other generative AI considerations (e.g., client control of whether and/or how client private data can be used, user control of whether AI-generated messages are reviewed before transmission, etc.);
facilitate management of rights to AI-generated work products (e.g., ownership, licensing, etc.);
detect generative AI usage in interpersonal communication, education and/or other situations (e.g., by scanning and/or otherwise looking for markers, particular inputs, and/or similarities in multiple work products, monitoring user activity, etc.; for notifying recipients, teachers, proctors, employers, etc.; etc.);
adapt AI-generated content of online communications based on their context (e.g., by adjusting their language, tone, content, etc. based on their recipients, times, types, purposes, etc.);
personalize AI-generated messages and other content (e.g., by training on user personal data);
trigger use of generative AI based on speech (e.g., at certain moments during discussions or other events, in voice messages, etc.);
limit or otherwise avoid generative AI usage (e.g., based on an extent of that usage for work, school, communication, and/or other purposes, based on certain contexts, etc.); and/or
improve use of generative AI in other ways.

A generative AI system 12 is configured to generate content, which may include text, images (e.g., still images or video), audio, program code, synthetic data, and/or other new content, based on inputs, such as requests (e.g., prompts) and/or other inputs from users 50, and a generative model 14 that learned from (e.g., trained on) reference data 16.

The generative model 14 is a machine-learning (e.g., deep learning) algorithm designed to learn from (e.g., train on) the reference data 16 in order to understand and generate content like that understandable and generatable by humans. In this embodiment, it comprises a neural network core 22 that includes one or more artificial neural networks, such as a transformer network (e.g., with attention mechanisms) for text generation, a generative adversarial network (GAN) for image generation, and/or a recurrent neural network (RNN) such as a long short-term memory (LSTM) for audio generation. Any suitable large language model (LLM) or other foundation model may be used in various embodiments. Fine-tuning may be used in some embodiments to train parameters of a pre-trained version of the generative model 14 on new data, such as a new portion of the reference data 16.

The reference data 16 on which the generative model 14 is trained may include public data that is publicly available on the internet and/or other public sources of data. Alternatively or additionally, the reference data 16 may include private data that is not publicly available, such as data owned by an individual or organization.

For example, in various embodiments, the reference data 16 may include or be derived from: text data such as literary texts (e.g., novels, short stories, plays, etc.), news articles (e.g., from newspapers, magazines, online news portals, etc.), scientific papers (e.g., research papers, conference proceedings, academic journals, etc.), social media posts (e.g., tweets, Facebook posts, Reddit comments, etc.), conversational data (e.g., transcripts of conversations from chatbots, customer service interactions, etc.), code repositories (e.g., source code from platforms like GitHub), blogs and web content (e.g. blog posts, online reviews, forum discussions, etc.), etc.; image data such as photographs (e.g., images from various categories like nature, urban, portraits, etc.), artwork (e.g., digital art, paintings, drawings, illustrations, etc.), medical images (e.g., MRI scans, X-rays, etc.), computer-generated images (e.g., for gaming, simulations, etc.), etc.; audio data such as speech recordings (e.g., of spoken languages, including various accents and dialects), music (e.g., tracks of different genres, instrumentals, vocals, etc.), sound effects (e.g., environmental sounds, synthesized sound effects, etc.), podcasts and audiobooks, etc.; video data such as movies and TV shows (e.g., full-length films, TV series, clips, etc.), user-generated videos (e.g., from platforms like YouTube, TikTok, Vimeo, etc.), surveillance footage (e.g., videos from security cameras), etc.; domain-specific data such as medical data (e.g., patient records, diagnostic reports, treatment histories, etc.), financial data (e.g., stock prices, financial news, market reports, etc.), legal documents (e.g., contracts, case law, statutes, etc.), e-commerce data (e.g., product descriptions, user reviews, transaction histories, etc.). etc.; and/or various other data.

Collecting and curating data for training the generative model 14 may involve web scraping to automatically collect data from the internet, collaborating with companies, institutions, and/or other organizations to access proprietary datasets, and/or utilizing open-access public datasets available for research and development. Also, before training the generative model 14, the reference data 16 may be prepared by preprocessing raw data to ensure it is in a suitable format for the model. For instance, this may include normalization, tokenization, augmentation, and/or annotation.

An input processing module 28 (e.g., input encoder) may be provided, such as a text encoder to convert textual inputs into numerical representations using techniques like tokenization and embedding, an image encoder to process image inputs through resizing, normalization, and other transformations and extract features, and/or an audio encoder to transform audio inputs into spectrograms or other feature representations.

An output processing module 30 (e.g., output decoder) may be provided to refine and format what is produced by the generative model 14. For example, for text, this may involve grammar checking; for images, this may involve post-processing filters, etc.

The generative AI system 12 may comprise one or more other processing modules 32 to process inputs (e.g., from users 50) other than through the neural network core 22. For instance, the one or more other processing modules 32 may implement one or more subroutines or other algorithms that may be invoked to process inputs like mathematical operations or other inputs that may not readily be processable by the generative model 14 in view of its training on the reference data 16.

Data storage 24 stores data related to operation of the generative AI system 12, including inputs (e.g., from users 50), parameters of the generative model 14, the reference data 16, and generated content. The data storage 24 may include one or more databases and/or may be implemented by one or more memories (e.g., that may be physically separate).

The generative AI system 12 may include a user interface (UI) module 34 to allow users 50 to provide inputs, such as by entering text, uploading images, and/or providing audio as well as by specifying settings (e.g., type, length, style, complexity, etc.) for content to be generated, and to display and/or otherwise output (e.g., via a speaker) content generated by the generative AI system 12.

For instance, in various embodiments, examples of what may be used as or as part of the generative AI system 12 include known generative AI technology such as chatbots like ChatGPT, Claude, Microsoft Copilot, and Gemini, text-to-image generators such as DALL-E, Stable Diffusion and Midjourney, text-to-video generators such as Synthesia and Sora, and text-to-code generators such as OpenAI Codex and GitHub Copilot.

Users 50 may use communication devices 110 to interact with the generative AI system 12, such as to provide inputs and/or receive, access (e.g., view and/or hear), and/or process AI-generated content produced by the generative AI system 12. Also, the users 50 may use the communication devices 110 to interact with the AI-use management system 10, such as in various embodiments further described below.

For example, in some embodiments, a communication device 110 may be a desktop or laptop computer, a smartphone, a tablet, a wearable device (e.g., a smartwatch or head-mounted display), a server, or any other computing device. The communication device 110 may comprise a user interface that includes a display, a speaker, and/or any other output device, and/or a touchscreen, a keyboard, a mouse or other pointing device, and/or any other input device. At least part of the user interface of the communication device 110 may be implemented as a graphical user interface (GUI). For instance, the user interface of the communication device 110 may cooperate with the UI module 34 of the generative AI system 12 for allowing a user 50 to provide inputs (e.g., enter text, upload images, and/or provide audio, specify settings for content to be generated, etc.) and for displaying and/or otherwise outputting content generated by the generative AI system 12. Also, the user interface of the communication device 110 may cooperate with the AI-use management system 10, such as in various embodiments further described below.

In some embodiments, a communication device 110 may communicate with the generative AI system 12, the AI-use management system 10 and/or one or more other communication devices 110 over one or more communication links 120, which may be wireless, wired, or partly wireless and partly wired (e.g., Bluetooth or other short-range or near-field wireless connection, WiFi or other wireless LAN, cellular, Universal Serial Bus (USB), etc.). In some cases, communication between the communication device 110 and the generative AI system 12, the AI-use management system 10 and/or the one or more other communication devices 110 may be direct, i.e., without any intermediate device. For instance, this may be achieved by pairing (e.g., Bluetooth pairing) the communication device 110 and the generative AI system 12, the AI-use management system 10 and/or the one or more other communication devices 110. In other cases, communication between the communication device 110 and the generative AI system 12, the AI-use management system 10 and/or the one or more other communication devices 110 may be indirect, e.g., through one or more networks and/or one or more additional communication devices. For instance, the communication device 110 may communicate with a WiFi hotspot or cellular base station, which may provide access to the internet or another network, thereby allowing the communication device 110 and the generative AI system 12, the AI-use management system 10 and/or the one or more other communication devices 110 to communicate.

In some examples of implementation, one or more applications (“apps”, i.e., software) may be installed on a communication device 110 to interact with the generative AI system 12 and/or the AI-use management system 10. For example, in some embodiments, such as where the communication device 110 is a smartphone, a tablet, a personal computer, etc., a user 50 may download the one or more apps from a repository (e.g., Apple's App Store, Google Play, etc.) or any other website onto the communication device 110. Upon activation of the one or more apps on the communication device 110, the user 50 may access certain features relating to the generative AI system 12 and/or to the AI-use management system 10 locally on the communication device 110. In addition, a data connection can be established over the internet with one or more servers which execute one or more complementary server-side applications interacting with the one or more apps on the communication device 110.

In other embodiments, a communication device 110 may implement (e.g., comprise) one or more components of the generative AI system 12 and/or the AI-use management system 10, in addition to or instead of communicating with the generative AI system 12 and/or the AI-use management system 10 over one or more communication links 120, thereby allowing one or more functionalities of the generative AI system 12 and/or of the AI-use management system 10 to be performed locally on the communication device 110.

With continued reference to FIGS. 1 to 3, in various embodiments, the AI-use management system 10 is configured to enhance, control and/or otherwise manage use of the generative AI system 12, notably by comprising a detection module 60 to detect use of generative AI, a characterization module 62 to characterize usage of generative AI, and an adaptation module 64 to adapt use of generative AI. For example, these modules may be configured for:
Detection of AI-generated content: detecting whether generative AI was used to generate certain content.

The detection module 60 may be configured to analyze characteristics of content to determine whether the content was generated by the generative AI system 12. In various embodiments, this may include analyzing a style, structure, and/or other features of the content, comparing the content against known AI-generated content, and/or applying machine-learning models trained to identify AI-generated content. Principles of known AI-content detectors such as GPTZero, TraceGPT, and Writer may be used for this purpose.

For example, in some embodiments, as part of a data collection and learning phase thereof, the detection module 60 may collect numerous and diverse writing samples, including both human-generated texts and AI-generated texts and learn to recognize patterns that differentiate AI writing and human writing and thus distinct characteristics of AI-generated texts. Subsequently, when presented with a new text (e.g., by a user 50), the detection module 60 compares it to what it learned during training, such as by analyzing the style, structure, word usage, grammar, and other features (e.g., “perplexity”, which refers to complexity and coherence of the new text, “burstiness” which assesses repetition of words and phrases) to determine a likelihood that at least part of the new text was AI-generated. Upon analyzing the new text, the detection module 60 generates a report or other output indicative of the likelihood that at least part of the new text was AI-generated.

Similar processes may be employed to detect other kinds of AI-generated content, such as images, audio or program code.
Characterization of AI-generated content: determining and/or specifying what and how AI-generated content was produced.

The characterization module 62 may be configured to determine various characteristics of certain content that is at least partially (i.e., partially or fully) generated by the generative AI system 12, such as an amount of AI-generated content that it includes (e.g., a percentage or other proportion of AI-generated content vs human-generated content), a duration of AI generation for the content (e.g., how much time was used to generate that AI-generated content vs how much time was spent by one or human producing that content), and/or an indication of one or more knowledge bases used in generating the content (e.g., one or more public portions of the reference data 16 such as the internet vs. one or more private portions of the reference data 16 such as data owned by one or more individuals or organizations).

Also, the characterization module 62 may be configured to qualify or otherwise specify certain characteristics of AI-generated content, such as an indication that the content was validated (e.g., reviewed) by one or more humans.
Adaptation of generative AI usage: adapting usage of generative AI based on context of content to be generated.

The adaptation module 64 may analyze factors relating to content to be generated by the generative AI system 12, such as a type (e.g., a topic, a nature, etc.) of the content, one or more recipients (e.g., an intended audience, one or more specific individuals, etc.) of the content, a purpose (e.g., professional, personal, etc.) of the content, and/or other relevant factors, and adapt the usage of generative AI accordingly. This may include selecting appropriate models, adjusting content parameters, and/or applying post-processing techniques to enhance relevance and appropriateness of the generated content.

For example, in various embodiments, these modules may implement one or more features including:

### 1. For Business

### 1.1 AI Usage Tracking

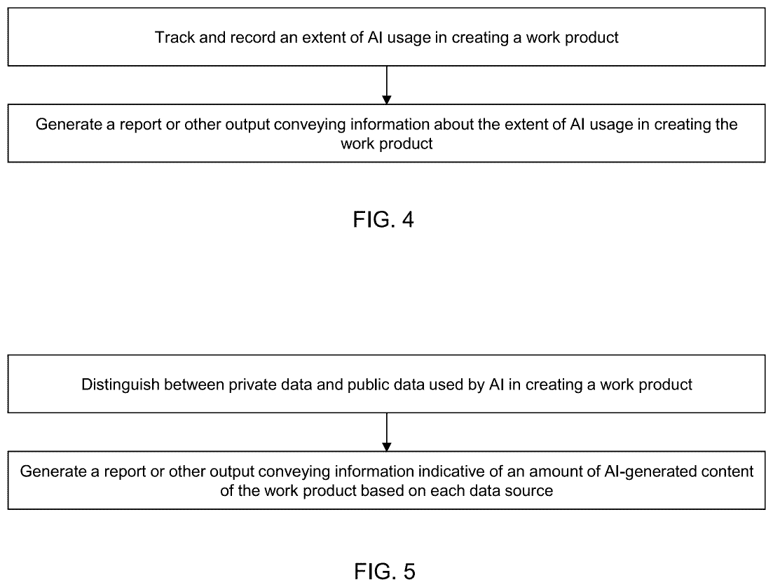

In some embodiments, as shown in FIG. 4, the characterization module 62 may track and record an extent (e.g., an amount, a duration, etc.) of usage of the generative AI system 12 in creating work products. For instance, it may log an amount of AI-generated content (e.g., number of words, sentences, paragraphs, etc. for text; number of pixels, data size, video length, etc. for images; number of notes, data size, audio length, etc. for audio elements; number of lines, routines, etc. for code; etc.) and/or log a period (e.g., one or more time intervals) of AI usage, and/or may calculate and report or otherwise output a proportion of total content involving AI and/or a proportion of total work time involving AI.

More particularly, in some embodiments, the characterization module 62 may assess a proportion of AI-generated content produced and/or of time spent by the generative AI system 12 in producing a work product, by monitoring and recording the extent (e.g., amount and/or duration) of generative AI usage in creating the work product. It may generate a report or other output conveying this information (e.g., which can be accessed by clients or employers to assess reliance on generative AI versus human input), which may be stored in the data storage 24 or other memory (e.g., of a communication device 110), displayed on a communication device 110, and/or printed on a tangible medium (e.g., hardcopy). The report or other output conveying this information may be provided together with or separate from the work product, either by default or on-demand (e.g., via a request made through the GUI of a communication device 110).

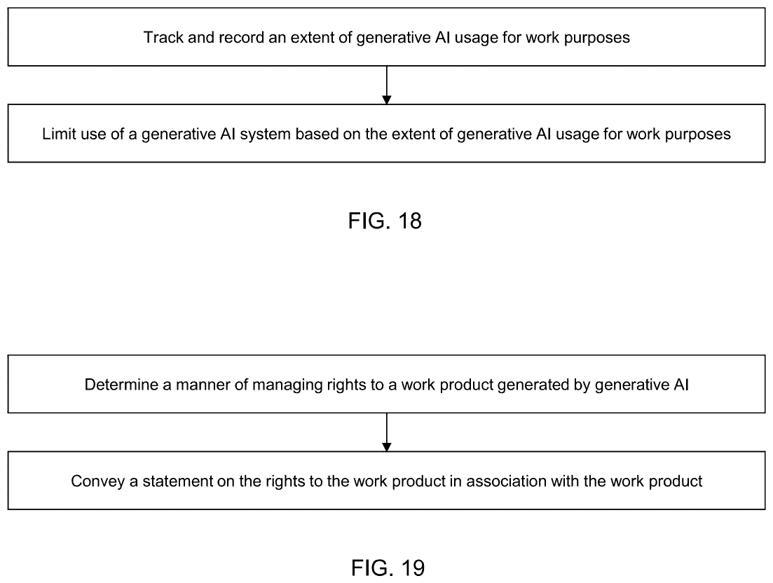

In some embodiments, as shown in FIG. 18, the adaptation module 64 may limit (e.g., reduce, cease, prevent, etc.) usage of the generative AI system 12 in producing AI-generated content based on the extent of usage of the generative AI system 12, such as when the characterization module 62 determines that the extent of usage of the generative AI system 12 reaches a threshold (e.g., a threshold amount of AI-generated content and/or a threshold duration of generative AI usage, above which further use of the generative AI system 12 may be deemed excessive or otherwise unacceptable). For example, in some cases, this may be done for: a work product (e.g., when the amount of AI-generated content produced and/or of time spent by the generative AI system 12 in generating the work product reached a threshold); a set of work products, which may be for a given client and/or by a given employee, team, department or other group (e.g., when the amount of AI-generated content produced and/or of time spent by the generative AI system 12 in generating the set of work products reached a threshold); for an employee, team, department or other group in performing its duties (e.g., when the amount of AI-generated content produced and/or of time spent by the generative AI system 12 for the employee, team, department or other group over a certain period of time reached a threshold); for a client in performing work for the client (e.g., when the amount of AI-generated content produced and/or of time spent by the generative AI system 12 for the client over a certain period of time reached a threshold); etc.

Upon the characterization module 62 determining that the extent of usage of the generative AI system 12 reaches a threshold, the adaptation module 64 may limit usage of the generative AI system 12 in various ways. For instance, in some embodiments, the adaptation module 64 may notify a user 50 (e.g., an employee using the generative AI system 12, a supervisor of such an employee, a client for which the generative AI system 12 is being used, etc.) that the threshold has been reached such as by sending an email, an instant message, or other notification to a communication device 110 of the user 50. In some embodiments, the adaptation module 64 may disable, block or otherwise prevent use of the generative AI system 12 so it can no longer be used for what reached the threshold. This prevention may remain in effect unless a condition (e.g., which may be set by default or specified by a user 50 such as an employee or client via his/her communication device 110) is satisfied, such as until a certain period of time (e.g., a number of hours, days, weeks, etc.) passes, until a certain amount of work product (e.g., text, images, code, etc.) is produced by one or more employees without using generative AI, until an authorization to resume usage of the generative AI system 12 for what reached the threshold is received (e.g., as a command entered by a supervisor, client, or other person with authority via his/her communication device 110), etc.

In various examples, legal, accounting, consulting and other professional firms can track AI usage during projects and production of work products to evaluate efficiency and cost-effectiveness and/or to provide transparency to clients, employers can assess how much generative AI is used by employees, etc. For instance, the characterization module 62 may log how much time the generative AI system 12 is active during production of a report by a firm for a client and/or how much content was generated by the generative AI system 12 and included in the report. It may, for example, record that the generative AI system 12 was active 1.5 hours out of a total 10-hour work session drafting the report and/or generated 60% of text and images contained in the report, perform data analysis, and generate visualizations that convey this information.

In some embodiments, a portion of content (e.g., text, an image, audio, code, etc.) that was initially generated by the generative AI system 12 may be deemed by the characterization module 62 to be AI-generated even if it was subsequently edited by one or more humans. In other embodiments, a portion of content (e.g., text, an image, audio, code, etc.) that was initially generated by the generative AI system 12 may no longer be deemed by the characterization module 62 to be AI-generated if it was subsequently edited by one or more humans by a certain degree that may be specified (e.g., by default or on-demand by a firm, a client, a user, etc., such as via a communication device 110). For example, in some cases, a portion of content (e.g., text, an image, audio, code, etc.) that was initially generated by the generative AI system 12 may no longer be deemed by the characterization module 62 to be AI-generated if more than half or some other fraction of that portion of content was edited by one or more humans.

### 1.2 Data Source Categorization

In some embodiments, as shown in FIG. 5, the characterization module 62 may distinguish between private data sources (e.g., owned by one or more individuals or organizations) and public data sources (e.g., internet) that are part of the reference data 16 used by the generative AI system 12 in generating work products. For instance, it may tag content generated by the generative AI system 12 based on one or more data sources used to train the generative model 14 and provide reports or other outputs indicative of an amount (e.g., a percentage or other proportion) of AI-generated content based on each data source.

More particularly, in some embodiments, the characterization module 62 may distinguish between use of private data in the reference data 16 and use of public data in the reference data 16 by the generative model 14 in generating a work product, by tagging content generated using the private data versus content generated using the public data to produce the work product and calculate how much (e.g., a percentage or other proportion) of that AI-generated content was derived from the private data and how much was derived from the public data.

In some cases, the private data may be owned by a firm producing the work product. In other cases, the private data may be owned by a client for which the work product is prepared. In yet other cases, a given portion of the private data may owned by the firm while another portion of the private data may be owned (e.g., supplied) by the client, in which cases the characterization module 62 may calculate how much (e.g., a percentage or other proportion) of that AI-generated content was derived from the private data owned by the firm, how much was derived from the private data owned by the client, and how much was derived from the public data.

The characterization module 62 may generate a report or other output conveying this information (e.g., which can be accessed by clients to assess reliance on private data vs public data), which may be stored in the data storage 24 or other memory (e.g., of a communication device 110), displayed on a communication device 110, and/or printed on a tangible medium (e.g., hardcopy). The report or other output conveying this information may be provided together with or separate from the work product, either by default or on-demand (e.g., via a request made through the GUI of a communication device 110).

In various examples, financial advisory, legal, marketing and other professional firms can ensure client transparency, compliance, and/or intellectual property management by tracking the source of data used in reports that are at least partially AI-generated, can benefit from market differentiation by use of their proprietary data in AI generation of work products, can allow proprietary data of their clients to be integrated with yet distinguished from public data and/or their own proprietary data in generating work products for their clients, etc. For instance, a financial advisory firm can utilize the generative AI system 12 to draft a market analysis report, and the characterization module 62 may differentiate between data sourced from internal proprietary databases (e.g., historical client transactions, confidential market studies, etc.) and publicly available data (e.g., stock prices, news articles, economic reports, etc.) by tracking and logging the source of the data used by the generative model 14 and determining that the final report includes 60% content based on internal proprietary data and 40% based on public data.

1.3 Differentiated AI-human billing

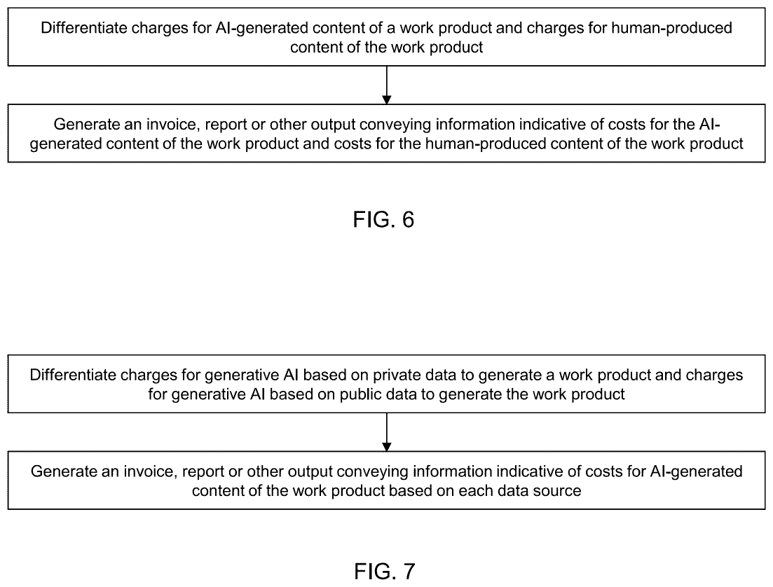

In some embodiments, as shown in FIG. 6, the characterization module 62 may differentiate billing (e.g., rates, fees and/or other charges) for AI-generated content versus human-produced content of work products. For instance, it may generate invoices, reports and/or other outputs detailing tasks completed by the generative AI system 12 and humans along with their respective costs for work products.

More particularly, in some embodiments, for a work product, the characterization module 62 may incorporate billing rates, fees and/or other charges for AI-generated content of the work product produced by the generative AI system 12 that are different from (e.g., smaller than) billing rates, fees and/or other charges for content of the work product produced by one or more humans. For instance, if the work product includes sections written by the generative AI system 12 and reviewed or enhanced by human experts, the characterization module 62 may reflect these details accordingly.

The characterization module 62 may generate an invoice, report or other output conveying this information (e.g., which can be accessed by clients to assess reliance on generative AI versus human input), which may be stored in the data storage 24 or other memory (e.g., of a communication device 110), displayed on a communication device 110, and/or printed on a tangible medium (e.g., hardcopy). If not an invoice, the report or other output conveying this information may be provided together with or separate from the work product and/or the invoice, either by default or on-demand (e.g., via a request made through the GUI of a communication device 110).

In various examples, legal, accounting, marketing and/or professional firms can transparently bill clients based on a proportion of work done by generative AI and human professionals, can retain records of AI usage for later auditing, client inquiries or other purposes, etc. For instance, a legal firm can use the generative AI system 12 to draft a contract or an opinion for a client, and the characterization module 62 may differentiate between (1) an amount of time (e.g., minutes or hours) the generative AI system 12 was active in generating the contract or opinion and/or an amount of AI-generated content (e.g., a number of words, paragraphs, sections, etc.; and/or a number of images, etc.) produced by the generative AI system 12 and included in the contract or opinion, and (2) time (e.g., minutes or hours) spent by one or more humans in drafting the contract or opinion and/or an amount of human-produced content (e.g., a number of words, paragraphs, sections, etc.; and/or a number of images, etc.) produced and/or edited by the one or more humans and included in the contract or opinion. As an example, if the generative AI system 12 drafts the contract or opinion in a total combined 30 minutes and a lawyer spends 2 hours reviewing, amending and adding to it, an invoice to the client can reflect separate rates for AI usage and human expertise. This transparency may help clients understand value added by AI and ensure fair billing practices.

In some embodiments, a portion of content (e.g., text, an image, audio, code, etc.) that was initially generated by the generative AI system 12 may be deemed by the characterization module 62 to be AI-generated even if it was subsequently edited by one or more humans. In other embodiments, a portion of content (e.g., text, an image, audio, code, etc.) that was initially generated by the generative AI system 12 may no longer be deemed by the characterization module 62 to be AI-generated if it was subsequently edited by one or more humans by a certain degree that may be specified (e.g., by default or on-demand by a firm, a client, a user, etc., such as via a communication device 110). For example, in some cases, a portion of content (e.g., text, an image, audio, code, etc.) that was initially generated by the generative AI system 12 may no longer be deemed by the characterization module 62 to be AI-generated if more than half or some other fraction of that portion of content was edited by one or more humans.

### 1.4 Billing Based on Data Source

In some embodiments, as shown in FIG. 7, the characterization module 62 may differentiate charges based on private data sources (e.g., owned by one or more individuals or organizations) and public data sources (e.g., internet) that are part of the reference data 16 used by the generative AI system 12 in generating work products. For instance, it may provide an invoice, report or other output describing a breakdown of costs associated with different data sources, enhancing trust and accountability between service providers and clients.

More particularly, in some embodiments, for a work product, the characterization module 62 may incorporate billing rates, fees and/or other charges for AI-generated content of the work product that is based on private data used by the generative AI system 12 which are different from (e.g., higher than) billing rates, fees and/or other charges for AI-generated content of the work product that is based on public data used by the generative AI system 12.

In some cases, the private data may be owned by a firm producing the work product, in which cases content AI-generated from that private data may incur higher costs due to a proprietary nature of that data for the firm. In other cases, the private data may be owned by a client for which the work product is prepared, in which cases content AI-generated from that private data may incur lower costs since it is provided by the client. In yet other cases, a given portion of the private data may owned by the firm while another portion of the private data may be owned (e.g., supplied) by the client, in which cases the characterization module 62 may calculate how much (e.g., a percentage or other proportion) of that AI-generated content was derived from the private data owned by the firm, how much was derived from the private data owned by the client, and how much was derived from the public data, and apply different billing rates, fees and/or other charges accordingly.

The characterization module 62 may generate an invoice, report or other output conveying this information (e.g., which can be accessed by clients to assess reliance on private data vs public data), which may be stored in the data storage 24 or other memory (e.g., of a communication device 110), displayed on a communication device 110, and/or printed on a tangible medium (e.g., hardcopy). If not an invoice, the report or other output conveying this information may be provided together with or separate from the work product and/or the invoice, either by default or on-demand (e.g., via a request made through the GUI of a communication device 110).

In various examples, marketing, consulting, legal and/or other professional firms can bill clients higher fees for AI-generated content using proprietary data versus public data, adjust their pricing based on how much of proprietary data is used such as lesser amounts if clients provided their own proprietary data for training of the generative model 14, etc. For instance, a marketing agency can use the generative AI system 12 to prepare advertisement material (e.g., one or more ads and a plan for an ad campaign, etc.) for a client, and the characterization module 62 can distinguish between a first portion of AI-generated content of the advertisement material derived from proprietary customer data of (e.g., other ad campaigns handled by) the marketing agency, a second portion of the AI-generated content of the advertisement material derived from proprietary data (e.g., geographical, demographic, and/or other sales information) of the client, and a third portion of the AI-generated content of the advertisement material derived from public data (e.g., reports on general market trend analyses) from general online sources, and charge more for the first portion of AI-generated content of the advertisement material derived from the proprietary customer data of the marketing agency than for the third portion of the AI-generated content of the advertisement material derived from the public data sources and/or charge less for the second portion of the AI-generated content of the advertisement material derived from the proprietary data of the client than for the first portion of AI-generated content of the advertisement material derived from the proprietary customer data of the marketing agency.

### 1.5 Human Validation

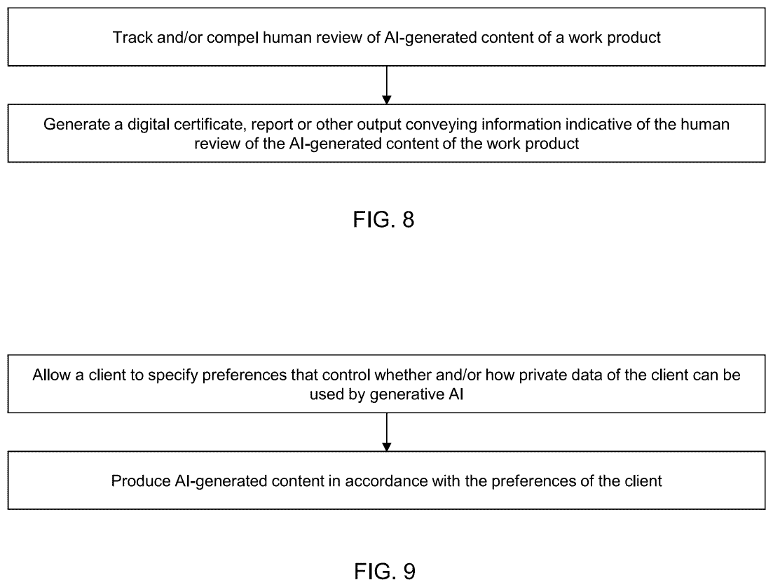

In some embodiments, as shown in FIG. 8, the characterization module 62 may provide indications (e.g., proof) of human review of AI-generated content of work products that is produced by the generative AI system 12. For instance, it may track when one or more humans review (e.g., read, edit, etc.) AI-generated content, log an identity of each human reviewer, a time at which the one or more humans' review occurred (e.g., start, end, duration, etc.), one or more sections (e.g., sentences, paragraphs, pages, images, etc.) reviewed by the one or more humans, and/or other relevant information about the one or more humans' review, and generate a digital certificate, report and/or other output confirming human oversight (e.g., with one or more digital signatures of the one or more humans who reviewed the AI-generated content). Alternatively or additionally, it may compel the one or more humans to actively engage with the content by introducing intentional obvious errors or placeholders in AI-generated content for correction, completion and/or other modification by the one or more humans.

More particularly, in some embodiments, for a work product, the characterization module 62 may track activity of one or more humans reviewing AI-generated content of the work product produced by the generative AI system 12 and issue a digital certificate, report and/or other output as proof of human review. In some cases, the characterization module 62 may implement a section-by-section review process whereby a human reviewer validates each part (e.g., paragraph, image, etc.) of the work product while the characterization module 62 records and tags each section as reviewed. This can be managed using interfaces similar to DocuSign, where each validated section is digitally signed.

Additionally or alternatively, the characterization module 62 may introduce intentional obvious errors or placeholders (e.g., “Two plus two equals five”, “This should be removed from a final product”, an illogical or missing object in an image, a bad or missing note in a music clip, etc.) in the AI-generated content of the work product that the one or more human reviewers are required to correct, complete and/or otherwise modify.

The digital certificate, report and/or other output by the characterization module 62 may be stored in the data storage 24 or other memory (e.g., of a communication device 110), displayed on a communication device 110, and/or printed on a tangible medium (e.g., hardcopy). The digital certificate, report or other output conveying this information may be provided together with or separate from the work product, either by default or on-demand (e.g., via a request made through the GUI of a communication device 110).

In various examples, legal, accounting, marketing and/or professional firms can keep track of which professionals reviewed which AI-generated content, prove to clients that AI-generated content in their work products was human-reviewed, etc., publishing houses can issue digital certificates for AI-generated manuscripts reviewed by human editors, etc. For instance, a publishing house can use the generative AI system 12 to produce a book draft, and the characterization module 62 verifies that AI-generated content of the book draft undergoes human editorial review and issue a digital certificate that may be embedded in the book draft's metadata, confirming human oversight and including timestamps, the human reviewer's identity, a summary of changes made, and/or other information providing a verifiable record of human review. As another example, a corporation may use the generative AI system 12 to draft sections of a comprehensive annual report, and the characterization module 62 may verify that each section, such as an executive summary or a financial analysis, is reviewed by different human experts by allowing each of these human reviewers to digitally sign off on a respective one of these sections that they are responsible for (e.g., adding notes or other comments, the reviewer's credentials and timestamp).

### 1.6 Client Data Control

In some embodiments, as shown in FIG. 9, the characterization module 62 may allow clients to control whether and/or how their data (e.g., financial information, technical information, legal information, market information, etc.) can be used in training, fine-tuning and/or applying the generative model 14. For instance, it may allow clients, such as via the GUI implemented by one or more communication devices 110 of the clients, to specify preferences for usage of their data, including allowing or denying usage, anonymization (e.g., to remove names and other information identifying individuals or organizations, etc.) and selection (e.g., which files may or may not be used, what categories of data may or may not be used, etc.).

More particularly, in some embodiments, for a client, the characterization module 62 may allow the client to interact via the GUI of a communication device 110 usable by the client to specify preferences such as allowing or denying use of their data, anonymizing sensitive information, and selecting which parts of their data can be utilized by the generative AI system 12. This may be done for any matter of the client or only one or more specific matters of the client. When the generative AI system 12 is then utilized to generate content for a work product, which may be prepared for the client or for any other purpose (e.g., internally, for another client, etc.), the generative model 14 proceeds to generate that content in accordance with the preferences of the client.

In various examples, financial, legal or healthcare clients can set specific controls over the use of their data for training and/or fine-tuning of the generative model 14 to ensure compliance with privacy regulations, clients can select only specific ones of their files to be used by the generative AI system 10 for different projects, etc. For instance, a client which is a law firm can use the generative AI system 12 to produce a report on due diligence conducted on a target company in potential acquisition, and the characterization module 62 may allow the law firm to specify that only certain reports previously prepared by the law firm for due diligence in transactions in an industry of the target company are to be used by the generative AI system 12 to produce the report on due diligence relating to the target company. As another example, a pharmaceutical company can set specific controls over how their data is used to train the generative model 14, such as by anonymizing patient data to be used and denying use of detailed treatment notes, etc.

1.7 Rights management

In some embodiments, as shown in FIG. 19, the characterization module 62 may determine how to manage rights to work products generated by the generative AI system 12 (e.g., ownership or licensing or other use of the work products) and may convey statements on the rights to the work products in association with the work products (e.g., as part of the work products themselves or accompanying documents that it produces).

When the generative AI system 12 generates a work product, the characterization module 62 may determine, based on the reference data 16 used by the generative AI system 12 in generating the work product and/or one or more other factors, a manner of managing rights to the work product. For example, in some cases, the characterization module 62 may determine that: a provider of the work product (e.g., a firm or other organization or an individual responsible for delivering or otherwise providing the work product) owns the work product but provides a license (e.g., exclusive, royalty-free, perpetual, etc.) to reproduce or otherwise use the work product to a recipient of the work product (e.g., a client for which the work product is prepared); the provider of the work product assigns ownership of the work product to the recipient of the work product; the recipient of the work product fully owns the work product outright; and/or any other terms pertaining to ownership, licensing, use, and/or other rights to the work product.

In some embodiments, the characterization module 62 may determine the manner of managing the rights to the work product based on the reference data 16 used by the generative AI system 12 in generating the work product. More particularly, in some embodiments, the characterization module 62 may determine the manner of managing the rights to the work product based on whether the reference data 16 used by the generative AI system 12 to generate the work product includes private data (e.g., owned by an organization or individual delivering or providing the work product or owned by a client for which the work product is prepared).

For instance, in some cases, the characterization module 62 may determine the manner of managing the rights to the work product when assessing that an amount of the private data used in generating the work product (e.g., number of words, sentences, paragraphs, etc. for text; number of pixels, data size, video length, etc. for images; number of notes, data size, audio length, etc. for audio elements; number of lines, routines, etc. for code; etc. of the private data that was used in generating the work product, which may be absolute or relative to (e.g., a percentage or other proportion of) a total amount of the reference data 16 that was used in generating the work product) reaches a threshold or meets another condition. Alternatively or additionally, in some cases, the characterization module 62 may determine the manner of managing the rights to the work product when assessing that an amount of AI-generated content for the work product derived from the private data (e.g., number of words, sentences, paragraphs, etc. for text; number of pixels, data size, video length, etc. for images; number of notes, data size, audio length, etc. for audio elements; number of lines, routines, etc. for code; etc. of the AI-generated content that is derived from the private data, which may be absolute or relative to (e.g., a percentage or other proportion of) total AI-generated content of the work product) reaches a threshold or meets another condition.

In addition to or instead of the reference data 16 used by the generative AI system 12 in generating the work product, in some embodiments, one or more other factors that may be considered by the characterization module 62 to determine the manner of managing the rights to the work product may include: an agreement related to the work product (e.g., established between the provider of the work product and the recipient of the work product, for that work product alone or for plural work products from the provider of the work product to the recipient of the work product) and establishing ownership, licensing, and/or other terms; a policy of the provider of the work product (e.g., defining terms for different types of work products providable by the provider of the work product, which may differ by types of conditions under which these work products are requested and produced, different types of information provided by recipients of these work products, etc.); and/or other information relevant to the work product. The characterization module 62 may receive or otherwise obtain data regarding these one or more factors based on input from a user 50 via the GUI of a communication device 110 and/or by consulting one or more databases accessible to the provider of the work product.

Upon determining the manner of managing the rights to the work product, the characterization module 62 may convey a statement on the rights to the work product in association with the work product. In some embodiments, the characterization module 62 may include the statement on the rights to the work product as part of the work product itself, i.e., a file of the work product, such as integrated in content (e.g., in a page or other section) of the work product or embedded in metadata of the file of the work product. Alternatively or additionally, in some embodiments, the characterization module 62 may include the statement on the rights to the work product as part of an accompanying document (e.g., such as a report distinguishing between use of private data and use of public data in generating the work product, as mentioned previously) that it generates to accompany the work product. In various examples, the statement on the rights to the work product may indicate that the provider of the work product owns the work product but provides a license to reproduce or otherwise use the work product to the recipient of the work product, the provider of the work product assigns ownership of the work product to the recipient of the work product; the recipient of the work product fully owns the work product outright, and/or any other terms pertaining to ownership, licensing, use, and/or other rights to the work product that was determined by the characterization module 62.

In various examples, as a marketing agency uses the generative AI system 12 to create a marketing report for a client, the characterization module 62 reviews the reference data 16 used to generate the marketing report, which includes public data sources, previous campaigns that are proprietary to the marketing agency, and recent client-provided data from the client itself, and, after assessing that a percentage of private data from the client used reaches a certain threshold (e.g., at least 30% of a total amount of the reference data 16 used), determines that the client should have ownership of the marketing report but the marketing agency retains a perpetual, royalty-free license to use the report, so that the marketing report includes a section on its final page explicitly outlining this licensing arrangement, while accompanying documentation provides an in-depth breakdown of the data sources and ownership rights; as a law firm uses the generative AI system 12 to generate a contract template for a client, the characterization module 62 determines that the reference data 16 used to create the contract template includes a mixture of publicly-available legal precedents and proprietary legal templates developed by the firm (private data of the firm) and assesses that only a small portion (e.g., 10%) of the contract template's content comes from the law firm's proprietary templates while the rest is generated from public legal frameworks, and therefore determines that the law firm retains ownership of the template but grants the client a non-exclusive, royalty-free license to use and modify the template as needed, and produces the contract template so that it contains a footer summarizing these rights, and an accompanying document delivered alongside the contract template and explaining the firm's ownership and licensing terms; as a software development company uses the generative AI system 12 to produce a software tool that automates client-specific tasks, the characterization module 62 analyzes the reference data 16, which includes proprietary code from the software development company and public libraries as well as specific requirements from the client (private data of the client), and determines that since a significant portion of the private data was used (e.g., 50% of the code consists of client-specific instructions), the client should own the work product outright and therefore the work product is delivered to the client with a statement embedded in the metadata of the code's file indicating full ownership by the client, and an accompanying document is provided to distinguishing between the client's private data and the public libraries used; etc.

### 2. For Education

### 2.1 Integrity

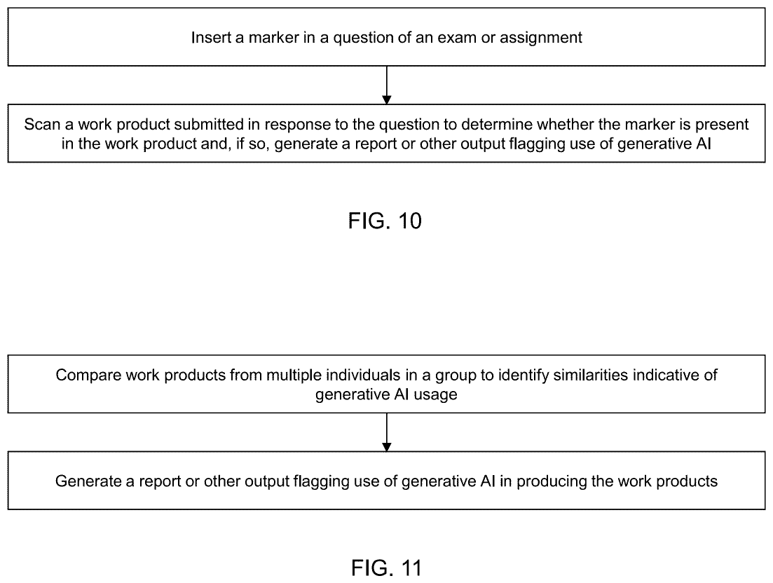

In some embodiments, as shown in FIG. 10, the detection module 60 may insert markers (e.g., specific phrases, images, data points, and/or other identifiable elements) into questions of exams or assignments to detect AI-generated content produced by the generative AI system 12. For instance, it may scan submitted work for the markers indicating that the work includes AI-generated content.

More particularly, in some embodiments, the detection module 60 may insert a Trojan horse or other marker into a question for an exam or assignment, and that marker is designed to reveal AI usage if a student or other individual used the generative AI system 12 to cheat in answering that question. The detection module 60 may scan submitted work in response to that question to determine whether the marker is present, flagging any instance where AI-generated content is detected by generating a report or other output conveying this information (e.g., which can be accessed by a teacher), which may be stored in the data storage 24 or other memory (e.g., of a communication device 110), displayed on a communication device 110, and/or printed on a tangible medium (e.g., hardcopy). The report or other output conveying this information may be provided together with or separate from the work, either by default or on-demand (e.g., via a request made through the GUI of a communication device 110).

In various examples, instructors can identify AI usage in student submissions by detecting specific markers, school or other administrators can evaluate an extent of AI usage in their establishment, etc. For instance, a teacher may design exam questions that include subtle markers that are recognizable by the teacher but likely overlooked by students using generative AI to cheat, so that an AI-generated answer produced by the generative AI system 12 might reproduce the marker, such as a specific phrase or data point, that flags the use of AI, when detected by the detection module 60.

### 2.2 Anti-Plagiarism

In some embodiments, as shown in FIG. 11, the detection module 60 may compare work products from multiple individuals in a group (e.g., students in a class) to identify similarities indicative of AI usage. For instance, it may use pattern recognition algorithms to detect content, stylistic and/or structural similarities across the work products that suggest that the work products all contain AI-generated content produced by the generative AI system 12.

More particularly, in some embodiments, the detection module 60 may compare student submissions (e.g., essays, short answers, etc.) to look for similarities indicative that the generative AI system 12 was used to produce these submissions, such as strikingly similar structures, wording, uncommon phrases, images, etc. (e.g., based on a number of occurrences of each of these content elements), and flag these submissions for further review by generating a report or other output conveying this information (e.g., which can be accessed by a teacher), which may be stored in the data storage 24 or other memory (e.g., of a communication device 110), displayed on a communication device 110, and/or printed on a tangible medium (e.g., hardcopy). The report or other output conveying this information may be provided together with or separate from the submissions, either by default or on-demand (e.g., via a request made through the GUI of a communication device 110).

In various examples, schools can identify classes, subjects or teaches that are more prone to or facilitate use of generative AI, teachers can identify groups of students that seemingly coordinate for work in their class, etc. For instance, in a university course, the detection module 60 may detect that two or more students' essays on “How climate change impacts bird migrations” share nearly identical passages, graphics, and/or other content, suggesting that these students used generative AI to produce their submissions.

### 2.3 Inputs Indicating Unpermitted AI Use

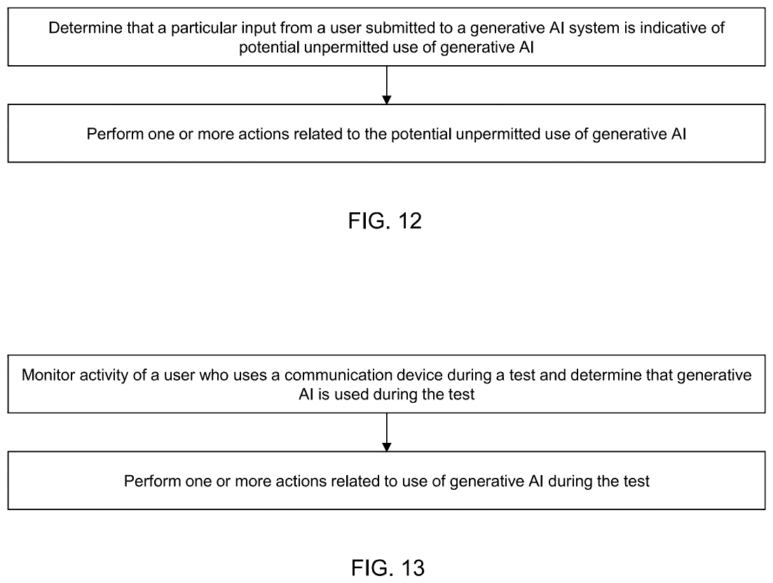

In some embodiments, as shown in FIG. 12, the detection module 60 may determine that inputs (e.g., prompts) from students and/or other individuals (e.g., candidates for professional licenses) submitted to the generative AI system 12 are indicative of potential unpermitted use of generative AI for school and/or other examination purposes, and may take appropriate actions in response to determining that.

For instance, in some embodiments, the detection module 60 may determine that a particular input (e.g., prompt) from a student or other user 50 submitted to the generative AI system 12 is indicative of potential unpermitted use of generative AI for school or other examination purposes. In some cases, the detection module 60 may determine that the particular input is similar to other inputs (e.g., identical to or containing a high proportion of words, phrases, paragraphs, images, sounds, etc. of the other inputs) which have been provided to the generative AI system 12 by other users (e.g., and stored in the data storage 24), and which may have been received in a given timeframe (e.g., within a few hours, one or more days or weeks, etc.), from a given geographical area (e.g., based on IP addresses of communication devices 110 from which the particular input and other inputs were made), etc. Alternatively or additionally, in some cases, a teacher or other examiner may have previously submitted a question of an exam or assignment to the generative AI system 12 (e.g., which may store the question in the data storage 24) and ask the detection module 60 to be on lookout for inputs containing or similar to that question, which may suggest that students or other individuals subject to that exam or assignment may be using generative AI to respond to that question.

Upon determining that the particular input from the student or other user 50 submitted to the generative AI system 12 is indicative of potential unpermitted use of generative AI for school or other examination purposes, the detection module 60 may perform one or more appropriate actions, such as refrain from generating AI content in response to the particular input, generate AI content but include a marker showing that it was generated by AI for recognition by the teacher or other examiner or advise the student or other user 50 that this AI-generated content should not be used for school or other examination purposes, notify the teacher or other examiner (e.g., via an email address of the teacher or other examiner who may have registered an account) of the potential unpermitted use of generative AI, etc.

In various examples, AI usage for school and/or other examination purposes can be detected and prevented based on broader consideration of inputs to the generative AI system 12 and/or proactiveness of teachers and/or other examiners. For instance, the detection module 60 may detect that several prompts for “describe advantages and disadvantages of self-driving vehicles” or similar prompts have been submitted to the generative AI system 12 during the last five days in a given city and/or may have previously received a question “what are advantages and disadvantages of self-driving vehicles” from a teacher who asked the detection module 60 to look for prompts containing or similar to that question, and may proceed to act accordingly to prevent or notify of generative AI usage.

### 2.4 Live Proctoring

In some embodiments, as shown in FIG. 13, the detection module 60 may monitor users 50 who are test-takers (e.g., students, candidates for professional licenses, etc.) taking tests in real time to detect usage of the generative AI system 12 by the users 50 during the tests and take appropriate actions upon such detection.

For instance, in some embodiments, the detection module 60 may monitor activity of a user 50 who is using a communication device 110 during a test (e.g., in an exam room or online) and determine that the generative AI system 12 is used during the test.

In some cases, the detection module 60 may determine that the generative AI system 12 is used during the test by determining that software associated with the generative AI system 12, such as a website for generating content with the generative AI system 12 accessible via a browser on the communication device 110 or an app for generating content with the generative AI system 12 installed on the communication device 110, is utilized (e.g., accessed, downloaded, invoked, etc.) during the test.

Alternatively or additionally, in some cases, the detection module 60 may determine that the generative AI system 12 is used during the test by determining that text and/or other content (e.g., images, audio, code, etc.) inputted by the user 50 at the communication device 110 into software used for the test (e.g., a word processing program like Microsoft Word, Google Docs, etc.; one or more answer fields of an app specific to the test; etc.) is indicative of usage of the generative AI system 12. For example, the detection module 60 may determine that the text and/or other content (e.g., images, audio, code, etc.) inputted by the user 50 at the communication device 110 into the software indicates that the generative AI system 12 is used based on a rate of input of the text and/or other content into the software, as a large amount of text and/or other content inputted in a short period of time, such as one or more bursts, may indicate that the text and/or other content was generated by the generative AI system 12 and then pasted, dragged and/or otherwise transferred into the software for the test.

The detection module 60 may monitor the activity of the user 50 by being connected to the communication device 110 over a communication link 120 (e.g., established via WiFi, Bluetooth, USB, etc.) or by running locally on the communication device 110 (e.g., as an app installed by the user 50 on the communication device 110 possibly as a requirement to take the test).

Upon determining that the generative AI system 12 is used during the test, the detection module 60 may perform one or more appropriate actions, such as notify a proctor of potential unpermitted use of generative AI (e.g., by transmitting an email or other message to a communication device 110 associated with the proctor; by issuing an audible or visual notification at a location of the user 50 in an exam room, such as via a light or speaker installed in the exam room at the location of the user 50 or via a speaker of the communication device 110 used by the user 50), notify the user 50 that one or more answers and/or other content he/she provided during the test is subject to review and potential refusal as having used generative AI (e.g., via an email or other message sent to the communication device 110 used by the user 50; via a notification in the software used for the test; etc.), etc.

In various examples, AI usage during live proctored exams can be detected and prevented based on proactive monitoring of test-takers. For instance, in a proctored online test during which students have to write an essay, the detection module 60 may detect that a student completed the test by entering his/her essay as a few small bursts of several paragraphs entered within a few seconds or minutes followed by tens of minutes of editing, suggesting that these initial quickly-entered paragraphs were generated by the generative AI system 12, and may proceed to act accordingly to prevent or notify of generative AI usage.

### 2.5 Limited AI Usage

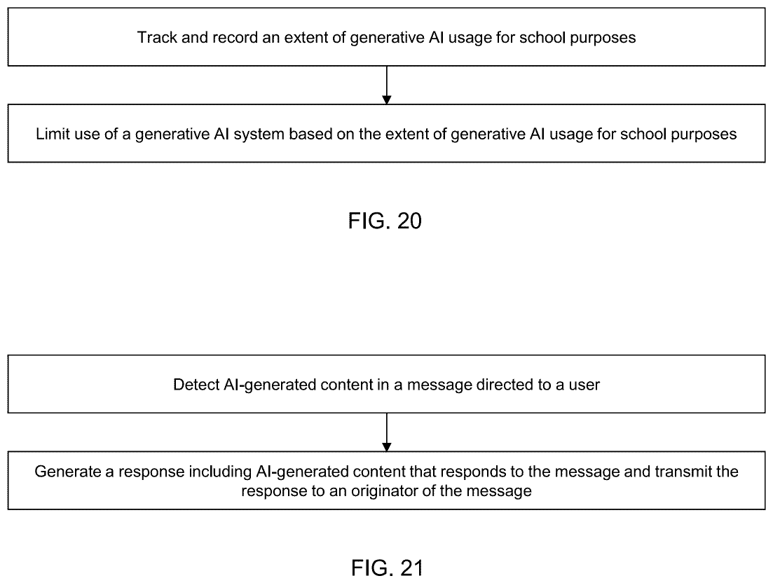

In some embodiments, as shown in FIG. 20, rather than banning generative AI usage altogether, schools may allow limited usage of the generative AI system 12 by students by utilizing the AI-use management system 10 to monitor how much the generative AI system 12 is used by the students in creating their submissions (e.g., essays, papers, artwork, music, programs, etc.) and to perform actions limiting that usage (e.g., according to limits acceptable to the school).

More particularly, in some embodiments, the characterization module 62 may track and record an extent (e.g., an amount, a duration, etc.) of usage of the generative AI system 12 by a user 50 who is a student at a school in creating one or more submissions. For instance, it may log an amount of AI-generated content (e.g., number of words, sentences, paragraphs, etc. for text; number of pixels, data size, video length, etc. for images; number of notes, data size, audio length, etc. for audio elements; number of lines, routines, etc. for code; etc.) and/or log a period (e.g., one or more time intervals) of AI usage, and/or may calculate and report or otherwise output a proportion of total content involving AI and/or a proportion of total work time involving AI. It may generate a report or other output conveying this information (e.g., which can be accessed by a teacher or other official of the school to assess reliance of the student 50 on generative AI versus the student's human input), which may be stored in the data storage 24 or other memory (e.g., of a communication device 110), displayed on a communication device 110, and/or printed on a tangible medium (e.g., hardcopy). The report or other output conveying this information may be provided together with or separate from the submission, either by default or on-demand (e.g., via a request made through the GUI of a communication device 110).

The adaptation module 64 may limit (e.g., reduce, cease, prevent, etc.) usage of the generative AI system 12 in producing the one or more submissions of the student 50 based on the extent of usage of the generative AI system 12, such as when the characterization module 62 determines that the extent of usage of the generative AI system 12 reaches a threshold (e.g., a threshold amount of AI-generated content and/or a threshold duration of generative AI usage, above which further use of the generative Al system 12 in generating the student's one or more submissions may be deemed excessive or otherwise unacceptable). For example, in some cases, this may be done for: a given submission of the student 50 (e.g., when the amount of AI-generated content produced and/or of time spent by the generative AI system 12 in generating the given submission reached a threshold); a set of submissions of the student 50, which may be for a particular class or for multiple classes (e.g., when the amount of AI-generated content produced and/or of time spent by the generative AI system 12 in generating the set of submissions of the student 50 reached a threshold); for a given class taken by the student 50 (e.g., when the amount of AI-generated content produced and/or of time spent by the generative AI system 12 for all submissions of the student 50 in that given class reached a threshold); for a given period of time of the student 50 at the school (e.g., when the amount of AI-generated content produced and/or of time spent by the generative AI system 12 for all submissions of the student 50 in all his/her classes over the given period of time reached a threshold); etc.

Upon the characterization module 62 determining that the extent of usage of the generative AI system 12 reaches a threshold, the adaptation module 64 may limit usage of the generative AI system 12 in producing the one or more submissions of the student 50 in various ways. For instance, in some embodiments, the adaptation module 64 may notify the student 50 and/or one or more teachers of the student 50 that the threshold has been reached such as by sending an email, an instant message, or other notification to a communication device 110 of the student 50 and/or of each of the one or more teachers of the student 50. In some embodiments, the adaptation module 64 may disable, block or otherwise prevent use of the generative AI system 12 so it can no longer be used by the student 50 for what reached the threshold. This prevention may remain in effect unless a condition (e.g., which may be set by default or specified a teacher or other employee of the school via his/her communication device 110) is satisfied, such as until a certain period of time (e.g., a number of hours, days, weeks, etc.) passes, until a certain number of submissions (e.g., 3, 5, 10, etc.) are produced by the student 50 without using generative AI, until an authorization to resume usage of the generative AI system 12 for what reached the threshold is received (e.g., as a command entered by a teacher or other employee of the school with authority via his/her communication device 110), etc.

In various examples, as a student 50 writes an essay for a history class, the characterization module 62 tracks the student's use of the generative AI system 12 to assist in drafting the essay, determines that the essay contains 2,000 words, detects that 600 words were generated by the generative AI system 12, resulting in an AI usage proportion of 30%, calculates that the student spent 30 minutes of a total 2-hour work session interacting with the generative AI system 12, thus concluding that the AI usage exceeds the school's acceptable threshold of 20%, prompting the adaptation module 64 to notify the student 50 and his/her teacher and denying further use of the generative AI system 12 for a remainder of the assignment; as a student 50 creates digital artwork in an art class, the student 50 uses the generative AI system 12 to obtain several AI-generated images input into a collage and manually adds a few brushstrokes and colors, the characterization module 62 records the number of AI-generated pixels relative to the total artwork and detects that 70% of the artwork is AI-generated, which exceeds the school's threshold of 30%, so the adaptation module 64 sends a notification to both the student 50 and the art teacher, alerting them that the threshold has been reached, and prevents the student 12 from adding more AI-generated elements until he/she reduces the AI-generated content to below the acceptable threshold; a student 50 in a college writing course is allowed to use AI tools but with restrictions, and, over a one-week period, the characterization module 62 logs that the student 50 generated multiple essays with a combined total of 10,000 words, of which 6,000 words were AI-generated, which exceeds the school's weekly limit of 30% AI-generated content, such that, upon reaching this threshold, the adaptation module 64 sends notifications to both the student 12 and his/her instructor, and disables further use of the generative AI system 12 for the student's upcoming assignments unless the instructor approves additional AI assistance; etc.

### 3. For Interpersonal Communication

### 3.1 AI Use Detection

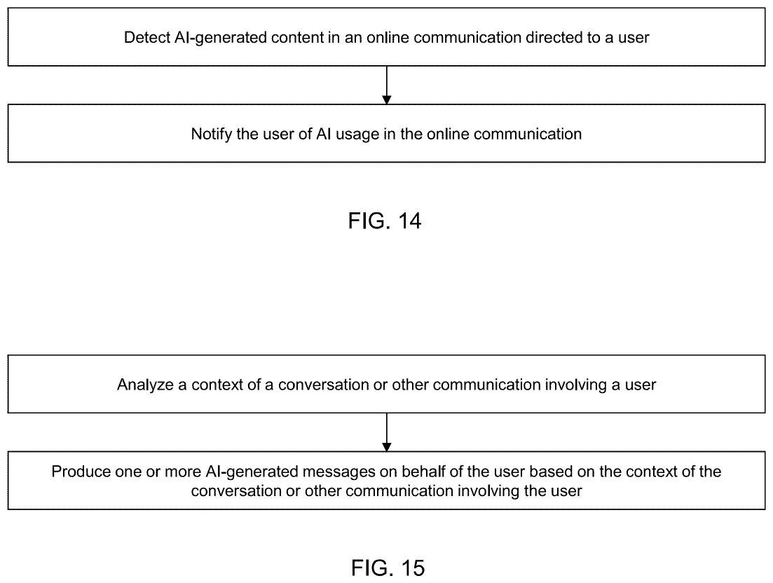

In some embodiments, as shown in FIG. 14, the detection module 60 may detect AI usage in online communications directed to users 50 and notify the users 50 thereof, such as to maintain transparency and trust.

For instance, in some embodiments, the detection module 60 may analyze message patterns, vocabulary, response timings, and/or other characteristics of one or more messages (e.g., instant messages, emails, etc.) directed to a user 50 to detect AI-generated content in these one or more messages, and notify the user 50 who receives these one or more messages of a likelihood of these one or more messages having been produced with generative AI, such as by appending a note, showing a graphical element, emitting a sound, and/or providing another indication of likely use of generative AI in these one or more messages when presented on a communication device 110 of the user 50.

In some embodiments, as shown in FIG. 21, upon detecting AI-generated content in a message directed to the user 50, the adaptation module 64 may generate an AI-generated response to that message on behalf of the user 50, so that the AI-generated response includes its own AI-generated content that may address or otherwise respond to the AI-generated content of the message directed to the user 50, and proceed to transmit the AI-generated response. This may be done in addition to or instead of notifying the user 50 that the message directed to the user 50 is deemed to have been AI-generated.

In some cases, generation and transmission of the AI-generated response to the message directed to the user 50 may be an option provided by the adaptation module 64 and selectable by the user 50 via the communication device 110 of the user 50 (e.g., a button or other graphical input in the GUI of the communication device 110), instead of the user 50 entering his/her own response to the message directed to the user 50. This may allow the user 50 to choose whether the AI-generated response (e.g., which may be suggested as a draft of the AI-generated response on the GUI of his/her communication device 110) should be transmitted. In other cases, generation and transmission of the AI-generated response to the message directed to the user 50 may be done automatically by the adaptation module 64 based on preferences of the user 50 previously specified by the user 50 via his/her communication device 110 (e.g., to indicate that any messages directed to the user 50 that include AI-generated content, or any such messages originating from (i.e., sent by) specific individuals, companies, or other originators (i.e., senders), during specific time periods, etc., are to be automatically responded to with AI-generated responses).

Also, in some instances, the AI-generated response to the message directed to the user 50 may indicate that the AI-generated content in the message directed to the user 50 was detected, i.e., that the message directed to the user 50 is deemed to have been at least partially AI-generated, in order to notify an originator (i.e., sender) of the message directed to the user 50 of this detection, and may request the originator to perform an action in this regard, such as confirming that information contained in the message directed to the user 50 is correct (e.g., accurate, true, etc.), elaborating on information contained in the message directed to the user 50, redrafting and resending the message directed to the user 50 without use of generative AI, no longer sending AI-generated messages to the user 50, etc. (e.g., “Your message may have been at least partially AI-generated.”, “Please confirm that [details mentioned in message] is correct and as you intended.”, “Please further explain [details mentioned in message].”, etc.).

Thus, in some embodiments, when receiving a message directed to a user 50, the detection module 60 may analyze the message (e.g., its vocabulary, timing, pattern, and/or other characteristics), and, if it detects AI-generated content in the message, it may notify the user 50 that the message was generated with generative AI and/or the adaptation module 64 may generate an AI-generated response to the message, whereas, if it does not detect AI-generated content in the message, it may take no particular action and rather let the user 50 handle the message conventionally as he/she desires.

In various examples, personal messaging apps can promote transparency by indicating AI-generated texts, individuals can become aware of when they are not merely communicating with human interlocutors, AI-generated messages can be flagged in workplace communications, AI-generated responses in customer service can ensure clients and/or customer service representatives are aware of AI versus human interactions, networking or dating apps can flag AI-generated introductory or other messages to encourage authenticity and promote genuine human interactions, etc.

For instance, the detection module 60 may detect AI usage in personal messaging such that if an AI-generated text is sent in a chat between friends, family members and/or other personal contacts, the detection module 60 may notify the recipient with a subtle indicator, such as a small icon or a footnote, that the message was generated by AI. In a corporate messaging platform between employees and/or other coworkers, the detection module 60 may flag messages suspected of being AI-generated, allowing recipients to request clarification or human follow-up if needed, such as if an employee uses AI to draft an email to a manager the detection module 60 may append a note indicating AI assistance was used, prompting the manager to ask for additional context or validation if necessary. In a customer service platform, the detection module 60 may distinguish between AI-generated and human responses, such that, when a customer interacts with a support agent, the system can mark AI-generated responses, ensuring that customers are aware when they are interacting with an AI versus a human representative.

### 3.2 Communication Management

In some embodiments, as shown in FIG. 15, the adaptation module 64 may adapt (e.g., tailor or otherwise customize) AI-generated responses (e.g., instant messages, emails, etc.) produced by the generative AI system 12 on behalf of users 50 based on contexts of conversations or other communications.

More particularly, in some embodiments, the adaptation module 64 may analyze a context of a conversation or other communication involving a user 50, notably one or more aspects of the conversation or other communication involving the user 50 such as a type (e.g., a topic, a nature, etc.) of the conversation or other communication, one or more recipients (e.g., an intended audience, one or more specific individuals, etc.) of the responses in the conversation or other communication, a purpose (e.g., professional, personal, etc.) of the conversation or other communication, and/or other relevant aspects, and craft and adjust AI-generated messages produced on behalf of the user 50 based on that context, thereby adapting conversation or other communication styles and content for specific individuals, scenarios, etc. The adaptation module 64 may generate responses and/or other messages that vary in tone and content based on these one or more aspects of the conversation or other communication, ensuring it is more appropriate and effective.

The user 50 may configure the adaptation module 64 via the GUI of a communication device 110 of the user 50 to automatically adjust language, tone, and content of AI-generated responses based on these one or more aspects. This may be done for any interlocutor communicating with the user 50 or for one or more specific interlocutors identified by the user 50. The adaptation module 50 may select from different conversational or other communicational modes appropriate for different scenarios, such as upon receiving a command from the user 50 via the GUI of the communication device 110 of the user 50 and/or upon making a determination based on context. For challenging conversations or other messages (e.g., breaking up, firing an employee, announcing loss of business, etc.), the adaptation module 64 may provide specially crafted responses and/or other messages designed to handle sensitive topics with care and/or professionalism.

In order to enhance communication involving the user 50 (e.g., so it appears more personal, deep, authentic, genuine, etc.), in some embodiments, the adaptation module 64 may include as part of an AI-generated response, which it generates on behalf of the user 50 based on the context of a given message received by the user 50 and which it transmits to an originator (i.e., sender) of the given message, one or more extraneous statements (e.g., sentences) unrelated to content of the given message but related to the originator of the given message. Each of the one or more extraneous statements included in the AI-generated response created by the adaptation module 64 does not answer or otherwise address any comment, question or other statement in the given message but is relevant, applicable or otherwise related to the originator of the given message. For example, the one or more extraneous statements included in the AI-generated response may be about: a personal event for the originator of the given message, such as his/her birthday, job promotion or other career change, wedding anniversary, move to a new home, purchase of a new car, a professional accomplishment, etc., which may be imminent or has recently occurred; a personal event for a family member or friend of the originator of the given message, which may be imminent or has recently occurred; weather, news or other current events occurring at a location of the originator of the given message and/or at a time at which the AI-generated response is to be sent; a work or other project in which the originator of the given message is involved; and/or any other event or aspect of life related to the originator of the given message.

The adaptation module 64 may generate the one or more extraneous statements to be included in the AI-generated response based on (e.g., by obtaining relevant information to make the one or more extraneous statements from): emails, instant messages, social media posts, and/or other personal data of the user 50 (e.g., which may refer to or otherwise be related to the originator of the given message); from social media posts of the originator of the given message; public internet sources (e.g., such as news sites, weather sites, etc. by searching based on the location of the originator of the given message and/or the time at which the AI-generated response is to be sent); and/or any other suitable information source accessible to it.

In some cases, inclusion of the one or more extraneous statements in the AI-generated response may be an option provided by the adaptation module 64 and selectable by the user 50 via his/her communication device 110 (e.g., a button or other graphical input in the GUI of the communication device 110). This may allow the user 50 to confirm whether the AI-generated response should include the one or more extraneous statements (e.g., which may be presented as suggestions in a draft of the AI-generated response on the GUI of his/her communication device 110). In other cases, inclusion of the one or more extraneous statements in the AI-generated response may be done automatically by the adaptation module 64 based on preferences of the user 50 previously specified by the user 50 via his/her communication device 110 (e.g., to indicate that any messages received by the user 50, or any such messages originating from (i.e., sent by) specific individuals, companies, or other originators (i.e., senders), during specific time periods, from specific locations, etc., are to be automatically responded to with AI-generated responses that include extraneous statements).

In some embodiments, the adaptation module 64 may include as part of an AI-generated response, which it generates on behalf of the user 50 based on the context of a message directed to the user 50 and which it transmits to an originator (i.e., sender) of that message, an indication that the AI-generated response has been generated by the generative AI system 12 so that the originator of that message is aware of this generative AI usage by the user 50 (e.g., and may possibly behave accordingly knowing that information contained in the AI-generated response may not have been personally conveyed, fully vetted or otherwise intended by the user 50). For instance, in some cases, the indication that the AI-generated response has been generated by the generative AI system 12 may include text indicative of generative AI use (e.g., “This message was produced using generative AI.”), a colored graphical element indicative of generative AI use (e.g., a graphical element in purple, orange, gray, or any other color or combination of colors that has been established, such as by a provider of the generative AI system 12 and/or the AI-use management system 10, to mean that messages were generated with generative AI, such as by having that colored graphical element encircle an AI-generated message, constitute at least part of a background of an AI-generated message, implement a flag or other icon appended to an AI-generated message, etc.), sound indicative of generative AI use (e.g., a vocal notification that “this message was produced using generative AI”, a distinctive ringing or other sound effect, etc.), and/or any other suitable indicator of generative AI use. In these cases, the indication that the AI-generated response has been generated by the generative AI system 12 is explicit and apparent from a communication device 110 of the originator of the message when he/she views or hears the AI-generated response. In other cases, the indication that the AI-generated response has been generated by the generative AI system 12 may be included as part of metadata accompanying the AI-generated message and accessible by the originator of the message via his/her communication device 110.

In various examples, personal AI assistants can adjust language, tone and content of AI-generated messages based on a relationship with an interlocutor (e.g., a friend, family member or other personal connection vs. a work colleague, client or other professional individual; a known interlocutor vs. an unknown or just-met interlocutor; etc.), a situation at hand (e.g., a personal vs. work-related event, a level of urgency or time-sensitivity, etc.), etc. For instance, the adaptation module 64 may utilize a more formal tone when interacting with a boss or client and a casual tone when interacting with a friend or family member, may be more concise in an urgent or other time-sensitive situation and more verbose in casual circumstances, etc.

### 3.3 Training AI on Personal Data

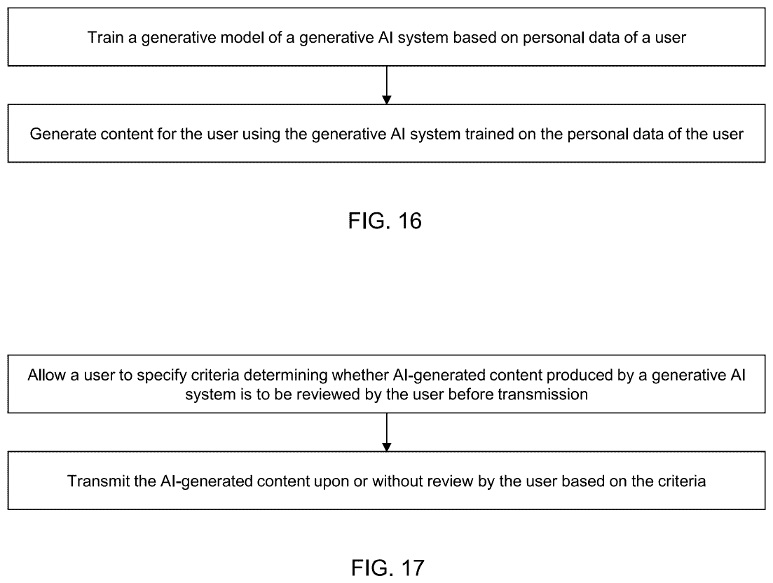

In some embodiments, as shown in FIG. 16, the adaptation module 64 may train the generative model 14 on personal data of users 50 and update frequently to ensure that AI-generated content (e.g., emails, instant messages, blog posts, professional work products, etc.) produced by the generative AI system 12 remains relevant and accurate with respect to the users 50.

More particularly, in some embodiments, the adaptation module 64 may train on emails, texts, instant messages, social media posts, blog posts, work products, and/or other personal data of a user 50, which forms part of the reference data 16 for the user 50, and update that training daily, weekly, monthly or otherwise frequently (e.g., whenever a certain number of new emails, texts, instant messages, etc. by or for the user 50 arise, which may be a single new email, text, instant messages, etc. or multiple ones). The adaptation module 64 may thus analyze the user's email, messaging, social media history to learn their writing style, preferences, common phrases, etc. in order to generate messages that closely mimic the user's natural communication style, improving relevance and effectiveness of AI-generated content produced for the user 50.

The adaptation module 64 may update the generative model 14 for AI-generated content for the user 50 frequently, such as by analyzing recent emails, instant messages, social media posts, etc. every few hours or every day to incorporate new slang, updates on ongoing projects, or changes in social or professional status, relationships. etc. so that AI-generated content produced for the user 50 stays current and accurate.

As various examples, users 50 can train their AI assistants with their past communications for more personalized responses, professionals can have their AI assistants generate emails, instant messages, etc. that reflect current, up-to-date or otherwise more relevant information relating to their work, etc.

3.4 Review control

In some embodiments, as shown in FIG. 17, the adaptation module 64 may allow users 50 to choose whether to review AI-generated responses produced by the generative AI system 10 on behalf of the users 50 before sending, thereby maintaining control over communications while benefiting from AI assistance.

More particularly, in some embodiments, the adaptation module 64 may allow a user 50 to specify criteria determining whether AI-generated content produced by the generative AI system 14 is to be reviewed by the user 50 before transmission, so that the AI-generated content is transmitted upon being reviewed by the user 50 or without being reviewed by the user 50 depending on whether the criteria (e.g., one or more recipients, one or more times of transmission, one or more types such as professional vs. personal, etc.) is met.

In various examples, users can opt to review AI-drafted emails in professional settings (e.g., to work colleagues, clients, etc.) to ensure accuracy and professionalism while not reviewing AI-drafted emails or texts in casual circumstances (e.g., to friends, family members, etc. to save time and effort), users can opt to review AI-generated emails or instant messages produced during daytime and not review AI-generated emails or instant messages produced at night, etc.

### 3.5 Limited AI Usage

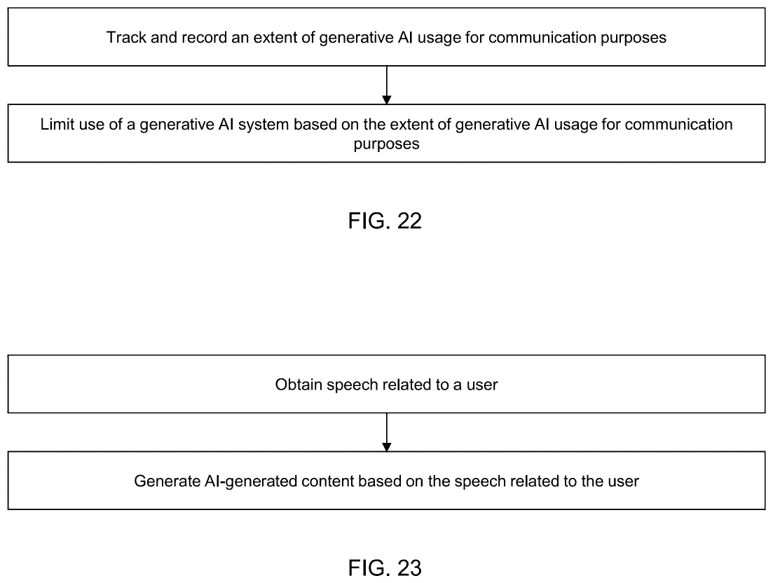

In some embodiments, as shown in FIG. 22, in order to avoid them excessively using generative AI in their communications, users 50 may restrict their usage of the generative AI system 12 by utilizing the AI-use management system 10 to monitor how much they use the generative AI system 12 in their communications (e.g., emails, instant messages, social media posts, etc.) and to perform actions limiting that usage (e.g., according to limits imposed by the users 50 themselves).

More particularly, in some embodiments, the characterization module 62 may track and record an extent (e.g., an amount, a duration, etc.) of usage of the generative AI system 12 by a user 50 in communications, such as emails, instant messages, social media posts, and/or other communications, which originate from him/her. For instance, it may log an amount of AI-generated content (e.g., number of words, sentences, paragraphs, etc. for text; number of pixels, data size, video length, etc. for images; number of notes, data size, audio length, etc. for audio elements; etc.) and/or log a period (e.g., one or more time intervals) of AI usage, and/or may calculate and report or otherwise output a proportion of total content involving AI and/or a proportion of total work time involving AI. It may generate a report or other output conveying this information (e.g., which can be accessed by the user 50 to assess his/her reliance on generative AI versus his/her human input), which may be stored in the data storage 24 or other memory (e.g., of a communication device 110), displayed on a communication device 110, and/or printed on a tangible medium (e.g., hardcopy). The report or other output conveying this information may be provided either by default or on-demand (e.g., via a request made through the GUI of a communication device 110).

The adaptation module 64 may limit (e.g., reduce, cease, prevent, etc.) usage of the generative AI system 12 in producing the communications of the user 50 based on the extent of usage of the generative AI system 12, such as when the characterization module 62 determines that the extent of usage of the generative AI system 12 reaches a threshold (e.g., a threshold amount of AI-generated content and/or a threshold duration of generative AI usage, above which further use of the generative AI system 12 in generating the user's communications may be deemed excessive or otherwise unacceptable). For example, in some cases, this may be done for: a given communication of the user 50 (e.g., when the amount of AI-generated content produced and/or of time spent by the generative Al system 12 in generating the given communication reached a threshold); a set of communications of the user 50, which may be with a particular person or with multiple people (e.g., when the amount of AI-generated content produced and/or of time spent by the generative AI system 12 in generating the set of communications 50 reached a threshold); for a given person (e.g., colleague, friend, family member, etc.) with whom the user 50 communicates (e.g., when the amount of AI-generated content produced and/or of time spent by the generative AI system 12 for all communications of the user 50 with that given person reached a threshold); for a given period of time (e.g., when the amount of AI-generated content produced and/or of time spent by the generative AI system 12 for all communications of the user 50 over the given period of time reached a threshold); etc.

Upon the characterization module 62 determining that the extent of usage of the generative AI system 12 reaches a threshold, the adaptation module 64 may limit usage of the generative AI system 12 in producing the communications of the user 50 in various ways. For instance, in some embodiments, the adaptation module 64 may notify the user 50 and/or one or more other individuals associated with the user 50 (e.g., parent or other family member, supervisor or other work colleague) that the threshold has been reached such as by sending an email, an instant message, or other notification to a communication device 110 of the user 50 and/or of each of the one or more other individuals associated with the user 50. In some embodiments, the adaptation module 64 may disable, block or otherwise prevent use of the generative AI system 12 so it can no longer be used by the user 50 for what reached the threshold. This prevention may remain in effect unless a condition (e.g., which may be set by default or specified by the user 50 via his/her communication device 110) is satisfied, such as until a certain period of time (e.g., a number of hours, days, weeks, etc.) passes, until a certain number of communications (e.g., 5, 10, 100, etc.) are originated by the user 50 without using generative AI, until an authorization to resume usage of the generative AI system 12 for what reached the threshold is received (e.g., as a command entered by a person with authority via his/her communication device 110), etc.

In various examples, a user 50 who works in a corporate setting enables the AI-use management system 10 to track its usage of the generative AI system 12 in producing his/her emails to monitor his/her reliance on that technology, the characterization module 62 logs that out of 100,000 words sent via email by the user 50 in a month, 70,000 words were generated by the generative AI system 12 and provides a report showing these statistics to the user 50, and the adaptation module 64 disables the user's access to the generative AI system 12 for emails for two weeks; a user 50 who posts frequently on social media decides to limit how much AI-generated content he/she uses in his/her posts to maintain an authentic personal brand, the adaptation module 64 is set to limit generative AI usage if it exceeds 50% in any given week, so when, over a week, the user 50 posts ten social media updates, with the generative AI system 12 composing five of them entirely and partially contributing to two others, the AI-use management system 10 logs that 55% of the user's social media content that week is AI-generated, triggering a notification to his/her communication device 110 that his/her usage has exceeded his/her limit, and then restricts the user 50 from using the generative AI system 12 for his/her next five social media posts to encourage more human-authored content; a user 50 who communicates with family members using the generative AI system 12 to help him/her write messages to them sets a threshold to limit AI usage if it generates more than 30% of his/her messages to any specific family member (e.g., his/her mother) in order to ensure the messages remain personal, so, after the characterization module 62 logs that the generative AI system 12 generated 35% of the user's messages to the specific family member in the last month, the AI-use management system 10 sends a notification of that to the user 50 and prevents the generative AI system 12 from being used in his/her messages to the specific family member for the next month or until the user 50 has written a series of at least five manually-composed messages to the specific family member; a user 50 who is an entrepreneur using the generative AI system 12 to assist with writing proposals for his/her business realizes that relying too heavily on AI could affect a creativity and a personal touch of his/her proposals, so he/she sets a usage limit and, over a month, the characterization module 62 logs that the generative AI system 12 was used for 85% of the content in proposals prepared in that month, exceeding his/her set threshold of 70%, such that the adaptation module 64 then temporarily disables access to the generative AI system 12 for proposal writing for one week, encouraging him/her to create at least one proposal manually, and, once he/she manually drafts the next proposal, access to the generative AI system 12 is automatically re-enabled; etc.

### 3.6 Voice-Triggered AI Use

In some embodiments, as shown in FIG. 23, the adaptation module 64 may generate summaries, responses (e.g., textual or vocal), and/or other AI-generated content (e.g., texts and/or graphics, diagrams and/or other images) and optionally transcripts based on speech related to users, which is what is said (i.e., uttered) to and/or by the users 50, such as during events (e.g., discussions, conference calls or other meetings, classes, seminars, etc.) involving the users 50 or in voice messages left for the users 50 (e.g., at their phone numbers, sent to their social media accounts, etc.).

More particularly, in some embodiments, the adaptation module 64 may obtain speech related to a user 50, namely what is said to and/or by the user 50, such as by recording what is said with a microphone of a communication device 110 of the user 50, and apply speech-to-text to convert what is said into text that may then be processed by the generative AI system 12 to produce a summary, response, and/or other AI-generated content based on what is said. The summary, response, and/or other AI-generated content based on what is said may be stored in the data storage 24 or other memory of the communication device 110 of the user 50 and/or displayed on the communication device 110 of the user 50. Alternatively or additionally, the summary, response, and/or other AI-generated content based on what is said may be transmitted to another communication device 110 (e.g., of a person who spoke at least part of what was said; a colleague, employer, friend, etc. of the user 50; etc.) over a communication link 120.

As an example, in some embodiments, the adaptation module 64 may generate a summary and/or other AI-generated content (e.g., text and/or a graphic, diagram and/or other image) and optionally a transcript based on what is said during an event (e.g., a discussion, a conference call or other meeting, a class, a seminar, an interview, a court proceeding, etc., which may be in-person or virtual, and/or live or pre-recorded) in which a user 50 participates and one or more other individuals (e.g., one or more other persons discussing with the user 50, one or more meeting attendees, one or more presenters, one or more teachers, one or more interviewees, one or more witnesses, etc.) and possibly the user 50 are speaking.

The adaptation module 64 may start at a particular moment to record what is said during the event for generating the summary and/or other AI-generated content based thereon. The particular moment may be at any point into the event (i.e., after a beginning of the event), such as any number of seconds or minutes, a quarter, halfway, three-quarters, or any other desired point into the event. For instance, in some embodiments, the particular moment may be specified by the user 50. In some cases, the user 50 may specify the particular moment by inputting a command into his/her communication device 110 (e.g., via a button or other control in the GUI of his/her communication device 110) at that particular moment (e.g., which may allow him/her to start this stealthily to avoid disruption). Thus, this may be activated on-demand by the user 50 whenever he/she wants during the event. In other cases, the user 50 may specify the particular moment by having previously specified a predetermined trigger (e.g., one or more keywords, expressions, topics, etc.) to be detected by the adaptation module 64 so that, at the particular moment, the adaptation module 64 detects the predetermined trigger (verbatim or as a close variant thereof) in what is said during the event and starts this process. In other embodiments, the adaptation module 64 may autonomously determine the particular moment (i.e., without specific commands or other dedicated inputs from the user 50). This may be done, for example, by the adaptation module 64 detecting a predetermined trigger that is derived by the adaptation module 64 based on emails, instant messages, social media posts, etc. of user 50 and that indicates a level of interest of the user 50 for what is said at that particular moment.

In some embodiments, the summary and/or other AI-generated content based on what is said during the event may be customized for the user 50. For instance, the user 50 may specify preferences via the GUI of his/her communication device 110 as to a level of detail (e.g., concise vs. verbose, specific quotes or not, time stamps of specific utterances, etc.), whether he/she desires a pictorial representation of what is said, etc. for the summary and/or other AI-generated content based on what is said during the event.

As another example, in some embodiments, the adaptation module 64 may generate a summary, text response, voice response, and/or other AI-generated content (e.g., text and/or a graphic, diagram and/or other image) and optionally a transcript based on what is said in a voice message left for a user 50 (e.g., at a phone number associated with the user 50 or in an instant message sent to a social media account of the user 50).

The adaptation module 64 may allow the user 50 to specify how and/or when to provide an AI-generated response (e.g., textual or vocal) to the voice message. For instance, in some cases, the user 50 may choose whether the AI-generated response is a text response or a voice response, which may emulate a voice of the user 50 (e.g., based on previous voice samples of the user 50 that are available to the adaptation module 64). Also, the user 50 may review the AI-generated response, such as by reading it or listening to it on a communication device 110 of the user 50, before it is sent to an originator (i.e., sender) of the voice message. Alternatively, based on preferences set up by the user 50, the adaptation module 64 may automatically transmit the AI-generated response to the originator of the voice message without review by the user 50.

Furthermore, in generating the AI-generated response, the adaptation module 64 may select from different response modes appropriate for different scenarios, such as upon receiving a command from the user 50 via the GUI of his/her communication device 110 and/or upon making a determination based on context including who is the originator of the voice message (e.g., a friend, family member or other personal connection vs. a work colleague, client or other professional individual; a known person vs. an unknown one; etc.), a situation at hand (e.g., a personal vs. work-related event, a level of urgency or time-sensitivity, etc.), etc. For instance, the adaptation module 64 may utilize a more formal tone for the AI-generated response when the originator of the voice message is a supervisor or client of the user 50 and a more casual tone for the AI-generated voice response when the originator of the voice message is a friend or family member of the user 50, may make the AI-generated voice response more concise in an urgent or other time-sensitive situation and more verbose in casual circumstances, etc.

The user 50 may specify a mode of delivery of the AI-generated response by interacting with the GUI of his/her communication device 110. For instance, when the AI-generated response is a voice response, it may be delivered via a phone call to a phone number associated with the originator of the voice message, an audio file attached to an email sent to an email address associated with the originator of the voice message, or an audio file included in an instant message sent to a social media account or phone number associated with the originator of the voice message. When the AI-generated response is a text response, it may be delivered via an email or text message sent to an email address, social media account or phone number associated with the originator of the voice message.

Also, the user 50 may specify at time at which to deliver the AI-generated response by interacting with the GUI of his/her communication device 110. For example, where the AI-generated response is a voice response, it may be delivered when the originator of the voice message is unlikely to answer a phone call (e.g., at night, outside of normal office hours, etc.) so that the voice response may be delivered straight to the originator's voicemail system; at a moment when the user 50 is available to engage in a conversation if the originator of the voice message answers the phone call; or at any other suitable time indicated by the user 50.

In one example, during a company meeting, a user 50 who is an employee attends with his/her communication device 110 (e.g., smartphone), the adaptation module 64 detects a start of the meeting based on a keyword trigger like “welcome” or “team updates,” which had been previously set by the user 50, and, as the meeting progresses, the adaptation module 64 captures the discussion through the microphone of the communication device 110, converts it to text using speech-to-text technology, and processes the conversation, so that, after the meeting ends, the adaptation module 64 generates a concise summary highlighting key points (e.g., deadlines, tasks, or project goals, specific quotes from the meeting, a visual diagram showing task distribution, etc.) and stores the summary on the user's communication device 110, send it via email to the meeting organizer and/or shares it with teammates.

In another example, a user 50 receives a voice message from his/her supervisor regarding a project update, the adaptation module 64 records the voice message and converts it to text, the user 50, while unavailable, has set preferences for generating an automatic voice response, the adaptation module 64 analyzes the voice message's content, determines that a formal response is appropriate based on the relationship (i.e., professional, supervisor), generates a voice response using the user's own voice, which it emulates based on previous voice samples, in which the response thanks the supervisor for the update and promises to follow up by the end of the day, and, as the user 50 had set a preference for responses to be sent automatically in urgent situations, the voice response is sent without review directly to the supervisor's email as an attached voice file.

In yet another example, a user 50 who is a student attends a virtual lecture on his/her communication device 110 (e.g., laptop) and wants to receive a summary of the class focused specifically on certain topics that he/she is studying for an exam, the adaptation module 64 starts recording automatically when the professor says “Chapter 5: Quantum Mechanics”, which a predetermined trigger set by the student, so that, once the lecture ends, the adaptation module 64 processes the content, generating a detailed summary that includes specific quotes, references, and diagrams explaining the concepts in question, and the summary is saved in the student's course folder in his/her communication device 110 and shared with his/her study group (e.g., by sending it to their respective email addresses).

In yet another example, a user 50 receives a voice message from a friend inviting them to a social gathering, the adaptation module 64 converts the voice message to text, then automatically generates a casual, informal voice response using the user's voice saying “Hey, thanks for the invite! I'll try to make it, let's catch up later”, which, based on the user's settings, is sent as an audio file to the friend's social media account, ensuring a quick and seamless interaction. The adaptation module 64 may also checks the user's calendar and may include in the voice response a suggestion of another date for a possible meetup if the user is unavailable for the original event.

In yet another example, during a legal proceeding involving a user 50 (e.g., who may be a party or lawyer to that party), the adaptation module 64 autonomously starts recording when it detects the predetermined trigger phrase “court is now in session” and, as multiple participants, including witnesses, lawyers, and the judge, speak, continuously records and transcribes the dialogue, so that after the session, it generates a summary separating key testimony and legal arguments, marking important sections with timestamps or including specific quotes to assist in post-hearing discussions, and including a diagram outlining the case's timeline or legal issues for the user's reference.

In yet another example, a user 50 receives a voice message from a client late at night requesting an urgent document update, the adaptation module 64 detects the urgency from the content and the professional relationship, generates an immediate, formal voice response in the user's voice that says “Thank you for your message. I will look into this first thing in the morning”, and, because the client might be unavailable at that hour, the system schedules the voice response to be sent as a voicemail in the early hours before the start of the next business day.

### 3.7 AI Use Avoidance

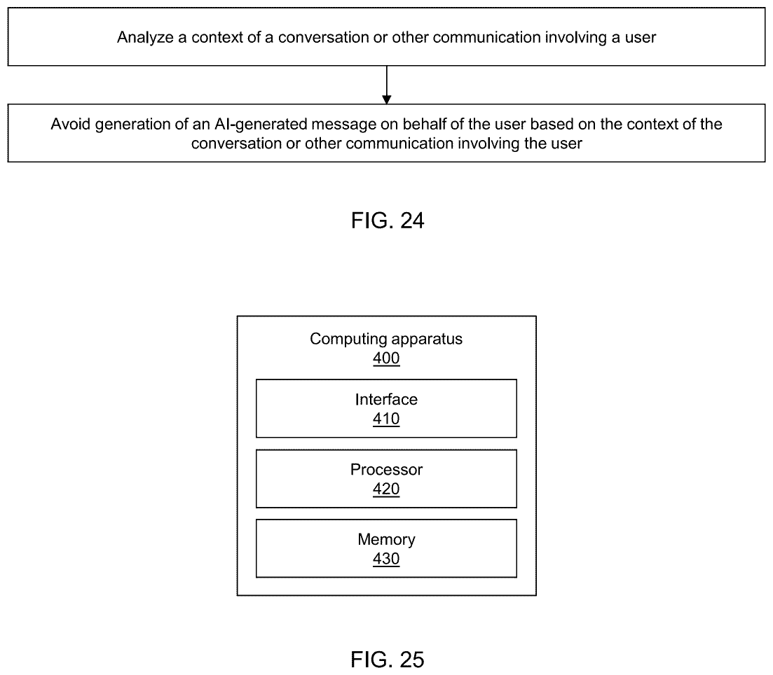

In some embodiments, as shown in FIG. 24, the adaptation module 64 may avoid generation of AI-generated responses (e.g., emails, instant messages, etc.) by the generative AI system 12 on behalf of users 50 based on contexts of conversations or other communications.

More particularly, in some embodiments, the adaptation module 64 may analyze a context of a conversation or other communication involving a user 50, notably one or more aspects of the conversation or other communication involving the user 50 such as a type (e.g., a topic, a nature, etc.) of the conversation or other communication, one or more recipients (e.g., an intended audience, one or more specific individuals, etc.) of responses in the conversation or other communication, a purpose (e.g., professional, personal, etc.) of the conversation or other communication, and/or other relevant aspects, and may determine, based on that context, that AI-generated messages on behalf of the user 50 should not be produced by the generative AI system 12 and therefore avoid generation of such AI-generated messages by the generative AI system 12.

The adaptation module 64 may determine, based on the context of the conversation or other communication involving the user 50, that no AI-generated message should be generated and thus avoid generation of an AI-generated message by the generative AI system 12 in various ways. For instance, in some embodiments, the adaptation module 64 may be configured to make that determination and proceed with that avoidance when the conversation or other communication involving the user 50 refers to a particular topic (e.g., a death, sickness, divorce or other serious event requiring compassion or other personal attention and input from the user 50), mentions a particular person (e.g., a specific individual or organization for which it is preferred that the user 50 respond personally), is at a particular time (e.g., a day or time of day at which it is preferred that the user 50 respond personally), requests or otherwise relates to sensitive or other confidential information (e.g., such as credit card information or other financial information about the user 50 or any other confidential information that should only be personally provided by the user 50), and/or is otherwise deemed to be better addressed by the user 50 himself/herself. In some cases, this may be set up by default for the AI-use management system 10. In other cases, this may be set up by the user 50 who may specify criteria for this via the GUI of his/her communication device 110.

In addition to avoiding generation of an AI-generated response by the generative AI system 12, the adaptation module 64 may notify the user 50 via his/her communication device 110 that the conversation or other communication involving the user 50 requires a personal response from the user 50. For instance, the adaptation module 64 may cause the communication device 110 of the user 50 to issue a notification, such as a pop-up window or other graphical element prompting the user 50 to personally respond and indicating a reason why this requires personal input from the user 50, a sound alerting the user 50, etc.

In various examples, a user 50 receives an email from a close friend about the death of a family member, the adaptation module 64 detects that the email refers to a deeply personal and emotional event (e.g., “I'm heartbroken to share the news that my mother has passed away”) and, based on the context and nature of the message and that the user 50 preconfigured the AI-use management system 10 to avoid AI-generated responses to messages containing key phrases such as “death,” “loss,” or “condolences” to ensuring he/she personally handles such communications, determines that this is a scenario where a compassionate, human response is necessary and therefore blocks the generation of an AI-generated reply by the generative AI system 12, instead prompting the user 50 to respond personally to convey the appropriate level of empathy and support; a user 50 is a business executive involved in an ongoing contract negotiation with a potential client, the adaptation module 64 determines that the communication involves sensitive discussions about pricing, contract terms, and sharing of proprietary information and has been pre-configured to avoid generating AI responses in these contexts due to the critical importance of confidentiality and accuracy, so when the client sends an email with a request for the user's final approval on specific contract terms, the adaptation module 64 detect that this is a professional and legally binding situation in which the user's personal input is essential, and, as a result, the adaptation module 64 blocks the generative AI system 12 from generating an automated response and prompts the user 50 to ensuring that he/she directly engages in the negotiation, providing thoughtful and precise replies; a user 50 preconfigures the AI-use management system 10 to avoid AI-generated responses whenever an email, text message or other communication involves a request for financial data or login credentials, such that when the user 50 receives an email from his/her bank asking him/her to verify recent transactions and provide updated billing information, the adaptation module 64 recognizes this type of message as involving sensitive financial details and, to ensure that his/her personal information remains secure, refrains from causing the generative AI system 10 to generate any automatic responses and alerts the user 50 to handle the communication manually; a user 50 receives a message inviting him to a close friend's wedding and containing personalized details, such as a location and time of the wedding and a handwritten note from the friend expressing excitement about the user's attendance, the adaptation module 64 analyzes the content of the email, recognizing that this is a significant social event that involves a personal connection, so, because responding to such invitations often requires thoughtfulness (e.g., confirming attendance, acknowledging the special occasion, or writing a heartfelt reply), the adaptation module 50 is preconfigured to determine that an AI-generated response would not be appropriate and therefore avoids generation of any automated reply by the generative AI system 12, and prompts the user 50 to personally respond to his friend; etc.

The AI-use management system 10 may be implemented in any suitable way in various embodiment. For example, in some embodiments, one or more components of the AI-use management system 10, such as the detection module 60, the characterization module 62 and/or the adaptation module 64, may be implemented by one or more communication devices 110 distinct and separate from the generative AI system 12. Alternatively or additionally, in some embodiments, one or more components of the AI-use management system 10, such as the detection module 60, the characterization module 62 and/or the adaptation module 64, may be implemented by the generative AI system 12. Thus, the AI-use management system 10, including the detection module 60, the characterization module 62 and/or the adaptation module 64, may be implemented entirely by one or more communication devices 110 distinct and separate from the generative AI system 12, entirely by the generative AI system 12, or partially by one or more communication devices 110 distinct and separate from the generative AI system 12 and partially by the generative AI system 12. For instance, in some cases, the detection module 60 may be implemented by one or more communication devices 110 distinct and separate from the generative AI system 12 while the characterization module 62 and/or the adaptation module 64 may be implemented by the generative AI system 12.

Embodiments of systems and methods disclosed herein therefore provide technical solutions to technical problems with AI, including AI content tracking, attribution, control, and transparency. These systems and methods are not merely abstract ideas, but instead provide practical applications and improvements to computer functionality, including improved data attribution, secure content generation, and enhanced communication efficiency.

For instance, features disclosed herein provide various technical improvements, including enhanced traceability of AI-generated content, improved user agency and data control in AI systems, more accurate and accountable cost and rights management, reduction in unauthorized or inappropriate AI usage, streamlined communications through intelligent content generation and delivery controls. These features represent specific and practical applications of AI technologies, embedded within computing environments that improve system operation, user interaction, and content governance. They are not directed merely to abstract ideas but solve concrete technical problems in AI integration and oversight.

As AI-generated content becomes increasingly indistinguishable from human-created work, technical challenges arise in identifying, attributing, and controlling such content within digital systems. Features disclosed herein address this by enabling systems to track and record an extent of AI usage, differentiate between private and public data inputs, and enforce user-defined controls regarding data usage and content generation. These capabilities overcome limitations of conventional computing systems, which lack native mechanisms for discerning content provenance or enforcing granular data governance in AI workflows.

Features disclosed herein further improve functioning of computing systems by introducing modules that enable real-time attribution, cost accounting, and AI usage enforcement, reducing reliance on post-hoc manual reviews or external tools. For instance, by providing context-aware AI message generation, automating human review workflows, embedding content markers, etc., these features enhance communication platforms' responsiveness and accountability. Additionally, user-facing controls within GUIs allow dynamic preference enforcement without interrupting core system operations, thus improving efficiency, security, and adaptability of AI-powered digital environments. These features represent technological improvements that enhance transparency, user control, and trust in generative AI systems, while also enabling more secure, efficient, and compliant deployment of AI technologies.

For example, providing an ability to track and record AI usage and to output information about a proportion and cost of AI-versus human-generated content enhances transparency and operational accountability of AI-enabled systems. By introducing metadata tagging, activity monitoring, and decision logic for cost attribution and review enforcement, features disclosed herein solve a technical problem of opaque AI content provenance and enables actionable, system-level decisions. Similarly, features that allow fine-grained user control over data usage, such as specifying which subsets of data may be accessed by AI or whether AI-generated responses should be reviewed before transmission, introduce technical improvements to data handling and content delivery pipelines of communication devices and computing systems. These solutions are not mental processes or generic computer functions; rather, they are specific, structured implementations that improve how computing systems manage AI content in real-time, with real-world operational consequences.

As another example, features disclosed herein improve functioning of computers and communication systems by reducing user burden, automating compliance with data governance preferences, and enhancing interpretability of AI-influenced communications. Features such as contextual analysis of communications to determine appropriate AI usage, dynamic notification of AI use in received messages, insertion and detection of markers to flag AI-generated content in academic or test-related environments, etc. all represent specific, technical solutions to problems arising from misuse or lack of transparency in generative AI applications. These features operate through defined data flows and control logic embedded in computing devices, rather than abstract analysis or human judgment.

As yet another example, features disclosed herein relating to tracking and recording an extent of AI usage and distinguishing between private and public data used by AI directly address technical challenges of transparency, attribution, and data governance in AI-driven content creation. By providing detailed breakdowns of AI-generated versus human-generated content, or content derived from private versus public data, these features enables more precise auditing, quality control, and intellectual property management for digital assets. This provides a technical solution to a problem of opaque AI usage, which can lead to issues with authenticity, ownership, and regulatory compliance. Furthermore, an ability to differentiate charges based on AI-generated content or data source (private vs. public) offers a novel technical solution to a problem of fair and transparent monetization of AI services, directly impacting economic models and operational efficiency of AI platforms. It allows for automated cost attribution and billing based on real-time analysis of content generation processes, which requires specialized data processing and output mechanisms.

As another example, features disclosed herein focusing on human review, preference specification, and rights management for AI-generated work products tackle critical technical problems related to quality assurance, user control, and legal clarity in an AI-augmented workflow. An ability to track and compel human review, or to allow users to specify preferences for private data usage, provides technical mechanisms for integrating human oversight and user agency into autonomous AI processes. This addresses a technical problem of ensuring accuracy, ethical compliance, and desired outcomes when AI is heavily involved in content creation. Similarly, determining and conveying rights associated with AI-generated work products offers a technical solution to complex legal and intellectual property issues arising from co-creation by humans and AI, providing a structured system for embedding and communicating metadata about ownership and usage rights. Also, features disclosed herein related to detecting and flagging unpermitted AI usage, such as scanning for markers in exam questions, comparing work products for similarities, or monitoring user activity during tests, all represent technical solutions to a growing problem of academic dishonesty and fraudulent content generation. These methods involve sophisticated pattern recognition, data comparison algorithms, and real-time monitoring of system interactions, directly improving integrity of assessment and content validation systems.

As yet another example, features disclosed herein relating to personalized AI interaction, such as training generative models on personal data, generating contextual messages, and providing granular user controls for data usage (e.g., via GUI controls to allow or deny data for training or content generation, or selecting specific data parts), represent significant technical advancements in user experience and data privacy within AI systems. These features address a technical problem of creating highly-customized and privacy-aware AI applications by implementing specific data management protocols, user interface designs that facilitate nuanced data sharing decisions, and adaptive AI model training processes. For instance, automatically generating time-sensitive messages or contextual responses based on a user's communications, emails, and instant messages, provides a technical solution to a problem of information overload and communication efficiency, improving overall functioning of communication devices and systems. These advancements enhance practical utility of generative AI by transforming it from a general content generator into a personalized and intelligent assistant, thereby improving functioning of computer systems by making them more responsive, efficient, and user-centric, and advancing human-AI collaboration.

In various embodiments, as shown in FIG. 25, any part of any element mentioned herein (e.g., the generative AI system 12, the AI-use management system 10, a communication device 110, etc.) may comprise a computing apparatus 400 including an interface 410, a processor 420, and memory 430, which are implemented by suitable hardware and software.

The interface 410 comprises one or more inputs and outputs (e.g., an input/output interface) allowing the processor 420 to receive input signals from and send output signals to other components to which the processor 420 is connected (i.e., directly or indirectly connected).

The processor 420 comprises one or more processing units for performing processing operations that implement functionality of the processor 420. A processing unit may be a general-purpose processing unit executing program code stored in the memory 430. Alternatively, a processing unit may be a specific-purpose processing unit comprising one or more preprogrammed hardware or firmware elements (e.g., application-specific integrated circuits (ASICs), electrically erasable programmable read-only memories (EEPROMs), etc.) or other related elements.

The memory 430 comprises one or more memory elements for storing program code executed by the processor 420 and/or data used during operation of the processor 420. A memory element may be a semiconductor medium (including, e.g., a solid-state memory), a magnetic storage medium, an optical storage medium, and/or any other suitable type of memory. A memory element may include a read-only memory (ROM) element and/or a random-access memory (RAM) element, for example.

A computer-readable storage medium referred to above may be a tangible device that can retain and store instructions in non-transitory form for use by an instruction execution device, such as a processor. The computer-readable storage medium may be, for example, an electronic storage device, a magnetic storage device, an optical storage device, an electromagnetic storage device, a semiconductor storage device, or any suitable combination thereof.

Computer-readable program instructions described herein can be downloaded to respective processing devices from such computer-readable storage medium or to an external computer or external storage device via a network, for example, the internet, a local area network, a wide area network, and/or a wireless network. The network may comprise copper transmission cables, optical transmission fibers, wireless transmission, routers, firewalls, switches, gateway computers and/or edge servers. A network adapter card or network interface in each processing device receives/obtains computer readable program instructions from the network and forwards the computer-readable program instructions for storage in the computer-readable storage medium within the respective processing device.

Aspects of this disclosure may be described herein with reference to flowchart/signal flow illustrations and/or block diagrams of methods, apparatus (e.g., systems), and computer program products according to various embodiments. Each block of a flowchart and/or block diagram, and combinations thereof, can be implemented by computer-readable program instructions.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing functions/acts specified in the flowchart and/or block diagram. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement functions/acts specified in the flowchart and/or block diagram.

The flowcharts and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s).

In some embodiments, any feature of any embodiment described herein may be used in combination with any feature of any other embodiment described herein.

Certain additional elements that may be needed for operation of certain embodiments have not been described or illustrated as they are assumed to be within a purview of those of ordinary skill in the art. Moreover, certain embodiments may be free of, may lack and/or may function without any element that is not specifically disclosed herein.

In describing embodiments, specific terminology has been resorted to for the sake of description but this is not intended to be limited to the specific terms so selected, and it is understood that each specific term comprises all equivalents.

In case of any discrepancy, inconsistency, or other difference between terms used herein and terms used in any document incorporated by reference herein, meanings of the terms used herein are to prevail and be used.

Although various embodiments and examples have been presented, this was for purposes of describing, but should not be limiting. Various modifications and enhancements will become apparent to those of ordinary skill in the art.

1-48. (canceled)

49. A system for managing use of generative artificial intelligence (AI), the system comprising memory and a processor configured to: provide a control in a graphical user interface (GUI) of a communication device of a user for the user to specify whether the user allows or denies data from the user to be used by the generative AI; if the user allows the data from the user to be used by the generative AI, utilize the generative AI for generating AI-generated content based on the data from the user and output the AI-generated content; and, if the user denies the data from the user to be used by the generative AI, deny use of the data from the user by the generative AI.

50. The system of claim 49, wherein, to utilize the generative AI for generating the AI-generated content based on the data from the user, the processor is configured to anonymize at least part of the data from the user.

51. The system of claim 49, wherein, to provide the control in the GUI of the communication device of the user, the processor is configured to provide the control in the GUI of the communication device of the user only for specific matters of the user instead of for any matter of the user.

52. The system of claim 49, wherein the data from the user includes a file of the user.

53. (canceled)

54. (canceled)

55. (canceled)

56. (canceled)

57. The system of claim 49, wherein, to provide the control in the GUI of the communication device of the user, the processor is configured to provide the control for the user to select which files of the user are allowed or denied by the user to be used by the generative AI.

58. The system of claim 49, wherein, to provide the control in the GUI of the communication device of the user, the processor is configured to provide the control for the user to select which data categories of the user are allowed or denied by the user to be used by the generative AI.

59. The system of claim 49, wherein, to utilize the generative AI for generating the AI-generated content based on the data from the user, the processor is configured to communicate with the generative AI over a wireless communication link.

60. (canceled)

61. The system of claim 49, wherein the generative AI is a chatbot.

62. The system of claim 49, wherein the generative AI is a text-to-image generator.

63.-73. (cancelled)

74. A system for managing use of generative artificial intelligence (AI), the system comprising memory and a processor configured to: determine a time sensitivity of a message directed to a user; utilize the generative AI to generate AI-generated content based on the time sensitivity of the message directed to the user;
and output the AI-generated content via a graphical user interface (GUI) of a communication device.

75. The system of claim 74, wherein the time sensitivity of the message directed to the user is indicative of a level of urgency of a situation mentioned in the message directed to the user.

76. The system of claim 74, wherein, to utilize the generative AI to generate the AI-generated content based on the time sensitivity of the message directed to the user, the processor is configured to utilize the generative AI to make the AI-generated content concise.

77. The system of claim 74, wherein the AI-generated content is an AI-generated instant message.

78. The system of claim 74, wherein the AI-generated content is an AI-generated email.

79-121. (canceled)

122. A system for managing use of generative artificial intelligence (AI), the system comprising memory and a processor configured to: utilize the generative AI to generate AI-generated content based on a message from a sender to a recipient; output the AI-generated content on a communication device; and convey an indication that the AI-generated content has been generated by the generative AI on the communication device.

123. The system of claim 122, wherein the indication that the AI-generated content has been generated by the generative AI comprises text of the AI-generated content.

124. The system of claim 122, wherein the indication that the AI-generated content has been generated by the generative AI comprises a graphical element associated with the AI-generated content.

125. The system of claim 124, wherein the graphical element associated with the AI-generated content is a graphical formatting element associated with the AI-generated content.

126. The system of claim 124, wherein the graphical element associated with the AI-generated content is a graphical color associated with the AI-generated content.

127. The system of claim 124, wherein the graphical element associated with the AI-generated content is a graphical icon associated with the AI-generated content.

128-189. (canceled)
